(19) United States
(12) Patent Application Publication
(10) Pub. No.: US 2022/0292335 A1
(43) Pub. Date: Sep. 15, 2022

(54) Reinforcement driven standard cell placement

(71) Applicant: NVIDIA Corp., Santa Clara, CA (US)

(72) Inventor: Haoxing Ren, Austin, TX (US)

(73) Assignee: NVIDIA Corp., Santa Clara, CA (US)

(21) Appl. No.: 17/679,681

(22) Filed: Feb. 24, 2022

Related U.S. Application Data
(60) Provisional application No. 63/158,662, filed on Mar. 9, 2021.

(51) Int. Cl. G06N 3/063; G06N 3/08; G06N 3/04

(52) U.S. Cl. CPC G06N 3/063; G06N 3/08; G06N 3/0454

(57) ABSTRACT

An automatic standard cell layout generator that generates circuit layouts for an industry standard cell library on an advanced technology node leverages reinforcement learning (RL) to generate device placements in the layouts and also to fix design rule violations during routing. A genetic algorithm is utilized to generate routing candidates to which a reinforcement learning model is applied to correct the design rule constraint violations incrementally. A design rule checker provides feedback on the violations to the reinforcement learning model and the model learns how to fix the violations. A layout device placer based upon a simulated annealing method may also be utilized.

### CROSS-REFERENCE TO RELATED APPLICATIONS

This application claims priority and benefit under 35 USC 119(e) to U.S. application Ser. No. 63/158,662, filed on Mar. 9, 2021, titled “Reinforcement driven standard cell placement”, the contents of which are incorporated herein by reference in their entirety.

### BACKGROUND

A “technology node” is a specific semiconductor manufacturing process and its design rules. Generally, the more advanced the technology node, the smaller the feature size, producing smaller transistors which are both faster and more power-efficient. Certain logic cells, called “standard cells”, are utilized as building blocks for advanced technology node layouts. Such layouts may be constructed from a very large number of instances of standard cells. Semiconductor companies and intellectual property providers may have teams dedicated to designing standard cell libraries for technology nodes. Each library may include thousands of standard cells. One cell design objective is minimizing cell width (cell height may be fixed within each library) to improve area efficiency.

Generating standard logic cell layouts in advanced technology nodes is challenging due in part to the exploding number and complexity of design rule constraints (DRCs), especially when the design goal is to minimize cell area. Different technology nodes often utilize different circuit generations and architectures in cell libraries. Previous approaches to generating standard cell layouts in advanced technology nodes leverage mathematical optimization methods such as Satisfiability Problem (SAT) and Mixed Integer Programming (MILP) to identify solutions under imposed constraints. These mathematical optimization methods rely on manual expression of design rules within an optimization framework and computational solvers.

Automating standard cell layout may not only speed up the design process, but also enable Design and Technology Co-Optimization (DTCO), which simultaneously optimizes standard cells and chip designs to achieve better performance. Standard cell layout design automation includes two primary operations: placement and routing. Placement locates devices and assigns pin locations in the layout. Routing connects device terminals and pins based on net connectivity.

Prior automated placement techniques include heuristic based methods, exhaustive search based methods, and mathematical programming based methods. The heuristic based methods first find all possible chains in the circuit, i.e. devices that can share diffusions consecutively, and then select a number of chains that cover all the devices. The exhaustive search based methods go through all possible device placement configurations and might use branch and bound or dynamic programming techniques to speed up the search process. The mathematical programming-based methods leverage MILP or SAT algorithms to find optimal device placement.

Prior routing techniques include channel routing, SAT, and MILP based routing methods. Commonly used deterministic channel routing methods such as LEA, Dogleg, Greedy, YACR2, etc., only generate a particular routing solution and do not handle DRCs well. SAT based routing creates candidate routes for each terminal pair and leverages SAT to find feasible routing candidates for all terminal pairs. It requires DRC checks to prune all conflicting routing candidates. The quality of routing candidates also limits the final routing quality. Therefore these techniques often cannot find routing solutions for complicated cells.

MILP based routing methods formulate the routing problem as a mixed integer linear programming problem. These method, however, rely on a MILP solver to solve a large number of constraints and require DRCs to be expressed in conditional equality or inequality form. This makes supporting newer technology nodes difficult. One conventional approach uses a combination of MILP and rip-up-reroute techniques to route, which would have similar issues to those mentioned previously.

Routing tends to be the more challenging of the two operations because routing needs to satisfy a (usually very large) set of configured DRCs. In advanced technology nodes, not only do the number of DRCs greatly expand, but the DRCs are tend to more complex. Much of the new complexity comes from DRCs that involve multiple layout shapes that were previously independent of each other. Mathematical optimization approaches based on SAT and MILP depend on the assumption that all design rule constraints can be expressed in the forms such as conjunctive normal form for SAT, or linear inequality for MILP. It is challenging or impossible to express all the DRCs efficiently in these forms. A large number of constraints are needed to handle all DRCs, which makes it difficult to scale to larger designs. Furthermore, it is often necessary to reformulate these constraints by hand for every new technology node or standard cell layout template.

One conventional approach that utilizes reinforced learning for routing problems creates routing direction actions, i.e., going north, south, etc. at each step. Another uses the attention model-based REINFORCE algorithm to select routing orders and uses a pattern router to generate actual routes once a routing order is determined. Yet another leverages both Monte Carlo Tree Search (MCTS) and deep neural network based directional action to find routes. Most of these approaches are limited to connecting the routes without consideration of design rule violations. These approaches are not readily extended to handle DRCs for complex circuits and/or standard cell routing domains.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A depicts a stick diagram for an embodiment of a standard latch cell.

FIG. 1B depicts a DRC-conformant metal layout for double patterning.

FIG. 1C depicts a DRC-violating metal layout for double patterning.

FIG. 2A depicts an example cell graph.

FIG. 2B depicts an example game process.

FIG. 3 depicts an example of determining a next device placement in a layout.

FIG. 4A depicts reinforcement learning placement logic in one embodiment.

FIG. 4B depicts an example of swapping PMOS/NMOS pairs in a layout.

FIG. 4C depicts a convolutional neural network for routability prediction in one embodiment.

FIG. 5 depicts a circuit element placement process in one embodiment.

FIG. 6 depicts a placement routine 600 in accordance with one embodiment.

FIG. 7A-FIG. 7F depict an exemplary placement sequence during inference by a reinforcement learning algorithm.

FIG. 8 depicts a circuit layout router 800 in accordance with one embodiment.

FIG. 9 depicts an incremental routing process 900 for advanced technology nodes in one embodiment.

FIG. 10 depicts a genetic routing algorithm 1000 in accordance with one embodiment.

FIG. 11 depicts a reinforcement learning artificial neural network 1100 for DRC correction in accordance with one embodiment.

FIG. 12A depicts an exemplary routed layout generated by a DRC configured genetic algorithm.

FIG. 12B depicts the routed layout of FIG. 12A after DRC fixes are applied by a reinforcement learning algorithm.

FIG. 13 depicts a parallel processing unit 1302a in accordance with one embodiment.

FIG. 14 depicts a general processing cluster 1400 in accordance with one embodiment.

FIG. 15 depicts a memory partition unit 1500 in accordance with one embodiment.

FIG. 16 depicts a streaming multiprocessor 1600 in accordance with one embodiment.

FIG. 17 depicts a processing system 1700 in accordance with one embodiment.

FIG. 18 depicts an exemplary processing system 1800 in accordance with another embodiment.

FIG. 19 depicts a graphics processing pipeline 1900 in accordance with one embodiment.

### DETAILED DESCRIPTION

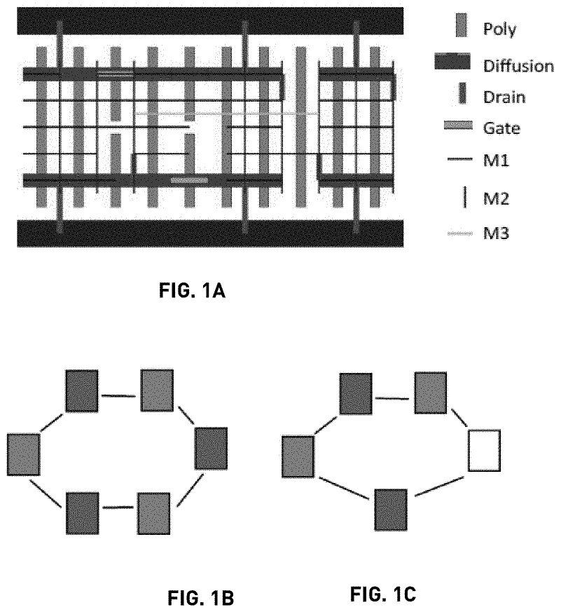

FIG. 1A depicts a stick diagram for an embodiment of a standard latch cell. Stick diagrams are well known techniques utilized to prototype circuit designs. A stick diagram may comprise the information utilized to generate a DRC-clean layout.

In the depicted stick diagram, nets may be routed in five different physical layers, referred to as Drain, Gate, M1, M2 and M3. The M1 and M3 layers are constrained to route horizontally while the M2 layers is constrained to route vertically. Drain connection locations essentially enable some vertical routing below M1, and Gate connections enable some (typically minimal) horizontal routing. There may typically be many constraints configured on how each layer may be routed. The most strict DRC rules are typically configured on the M1 layer. On the M1 layer, the routing shapes are constrained to be positioned on a fixed grid, and cut metal shapes are constrained to be inserted between adjacent routing segments on the same track. The locations of the cut metals may be inferred from the routing assignment, and typically is subject to many DRC constraints.

Stick diagrams constrain the placement of devices on particular locations along tracks. Stick diagrams also intrinsically determine where and whether it is legal (adhering to constraints) to cut certain base layers. Locations for vias, pins, and text labels are also inferred intrinsically. Because base layer shapes and metal shapes within a standard cell are constrained to a small set of permitted locations, a set of layout sub-cells may be generated comprising all legal shape permutations that adhere to a library template and DRC rules. These may be assembled into layout candidates. When routing a candidate layout, real-time (during routing) DRC checking may be utilized to provide ongoing feedback of DRC violations.

One type of DRC constraint requires closely-placed cut metal shapes to be colored differently, for double patterning. Double patterning is a technique that splits dense (closely-placed) patterns into two interleaved patterns of less-dense features, defined by two masks. Given sufficiently accurate alignment, the two patterns marry up on the wafer surface to create much denser features than could be achieved with one mask. Double patterning techniques may utilize two complementary-colored masks used in a litho-etch, litho-etch (LELE) process. Implementing double-patterning may require the number of shapes in a loop formed by the cut metals to be an even number as shown in FIG. 1B.

If the loop has an odd number of cut metal shapes as depicted in FIG. 1C, it becomes impossible to color it correctly. Implementing this type of DRC in MILP requires enumerating all possible loops formed by cut metals, increasing the number of constraints exponentially. However this DRC may be readily implemented utilizing embodiments of the disclosed techniques.

Simulated annealing algorithms for device placement may become computationally expensive for large circuit layouts. When used in conjunction with machine learning-based routability predictors, the computation cost (in time, energy, and machine cycles) may increase even further.

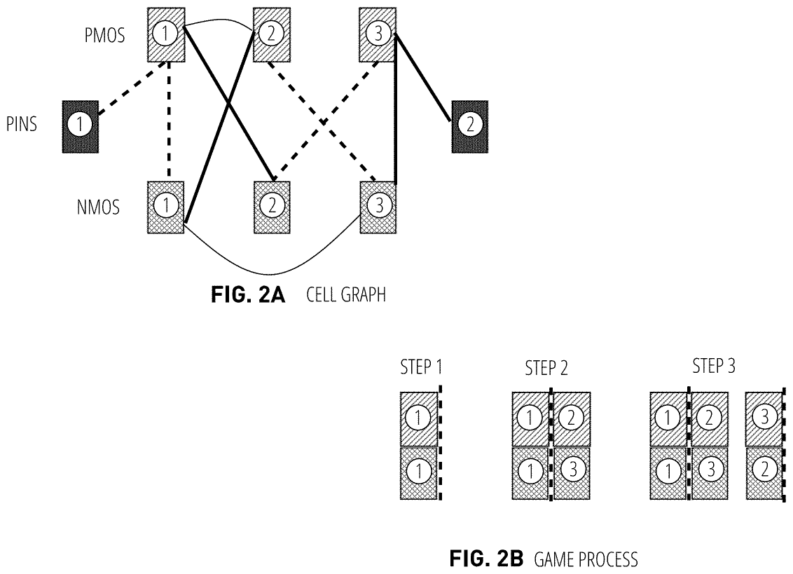

To ameliorate this problem a reinforced learning-based device placement algorithm (i.e., an RL placer) may be implemented to generate placements with accuracy on par with simulated annealing algorithms. Given a standard cell circuit netlist, the RL placer will place a pair of NMOS and PMOS devices along a layout, e.g., from left to right. The action space of the RL placer is the set of devices to pair together (within the cell layout) for each placement step. The action space also include which pin of the devices to place in the next step. A pin provides an input or output connection between the logic cell being laid out and external circuits that couple to the cell in a larger design. See FIG. 2A and FIG. 1B. Diagonally hatched boxes represent PMOS devices, cross hatched boxes represent NMOS devices, and dark shaded boxes represent pins.

In FIG. 2A, lines that extend from the center of the bottom or top edge of a device box indicate a connection at the poly gate terminal of the device. Lines that extend from the side edge of a device box indicate a connection to a diffusion terminal of the device. The graph network may comprise heterogeneous edge types such as diffusion-gate connection, gate-gate connection, gate-diffusion connection, diffusion-diffusion connection, gate-pin connection, pin-gate connection, diffusion-pin connection, and pin-diffusion connection. The edge type may be is one-hot encoded into a feature vector to represent the edge type in a graph neural network.

FIG. 2B depicts a process by which at step 1, PMOS device 1, NMOS device 1, and Pin 1 are placed. At step 2, PMOS device 2, NMOS device 3, and no pins are placed. At step 3, PMOS device 3, NMOS device 2, and Pin 2 are placed.

To support unpaired PMOS or NMOS devices, the RL placer incorporates dummy (unused in actual operation of the circuit) PMOS device and dummy NMOS devices in the the action space, as well as dummy pins. The state space of the RL placer is a graph made of nodes of PMOS, NMOS devices and pins, including the dummy devices and pins. The connectivity between the nodes is derived from the net connectivity. For each net, the RL placer instantiates two opposite edges between each terminal pair. The node attributes include node types, number of fins for each device, and placement attributes, i.e. whether the device is flipped or not in the placement. Edge attributes include edge types such as gate-to-source, source-to-drain, etc.

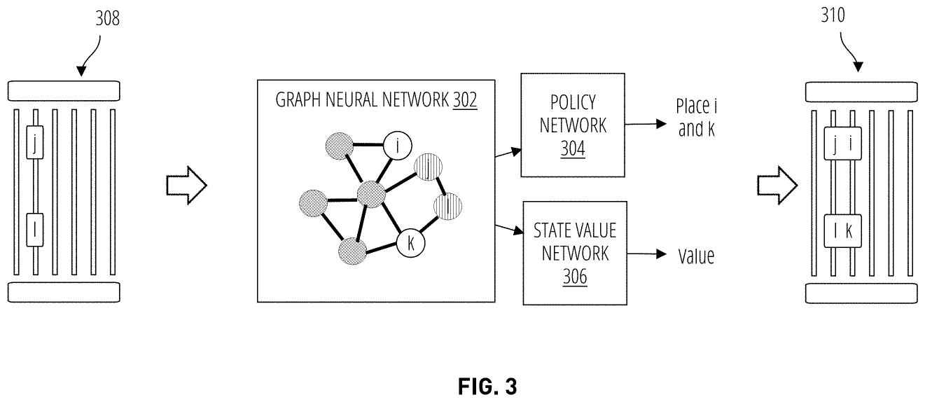

FIG. 3 depicts an example of determining a next device placement in a layout. Nodes i and k are unplaced devices, e.g., a PMOS and NMOS pair of devices to place together on the same poly of the layout. Unplaced pin nodes, although not depicted, are also part of the graph neural network 302. Cross hatched nodes are already placed devices, and vertically hatched nodes j and 1 are the most recently placed PMOS and NMOS device.

Many reinforcement learning algorithms are based on estimating value functions, which are functions of states (or of state-action pairs) that estimate the value of the algorithm being a given state (or how good it is to perform a given action in a given state). The notion of “how good” may be defined in terms of future rewards that can be expected, or, in other words, in terms of expected return. The rewards the agent (algorithm) can expect to receive in the future depend on what actions it will take. Accordingly, value functions are defined with respect to particular action policies the agent may implement.

The current state of placements 308 and unplaced devices is embedded in a graph neural network 302 that outputs updated node embeddings to a policy network 304 and a state value network 306, generating updated placements 310 (more specifically, action probability distribution for next placements) and a state value. The state value (V) is in one embodiment predicted from a maximal vector of updated node embeddings. The graph neural network 302 may be pre-configured using supervised learning on standard cell netlists and corresponding layouts generated manually or via simulated annealing.

Outputs of the graph neural network 302 may be evaluated based on a reinforcement learning reward function, and the reward value(s) applied as a feedback signal to further train the graph neural network 302, thus implementing unsupervised learning to further refine the configuration of the graph neural network 302. The reward can be based on design constraints such as overall cell size (smaller creates a higher reward) and congestion (lower is a higher reward). At the cost of some performance, routing complexity (lower is a higher reward) and pin placement optimality (e.g., for external routing flexibility) may also be considered in the computation of the reward.

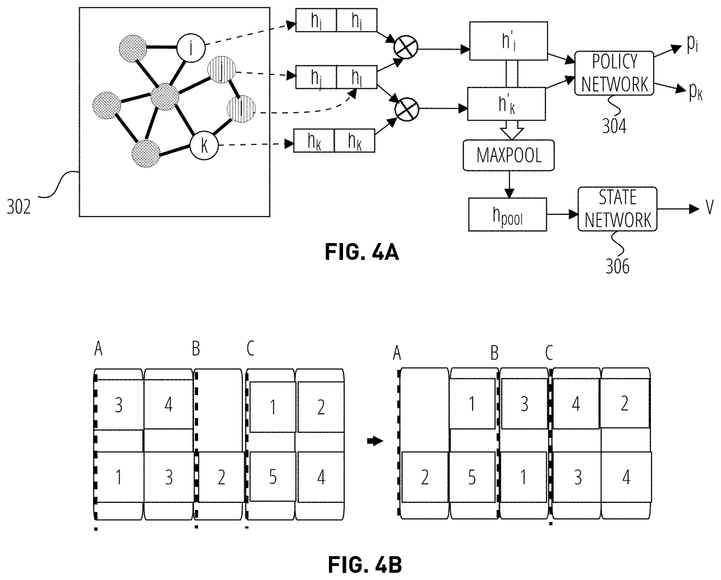

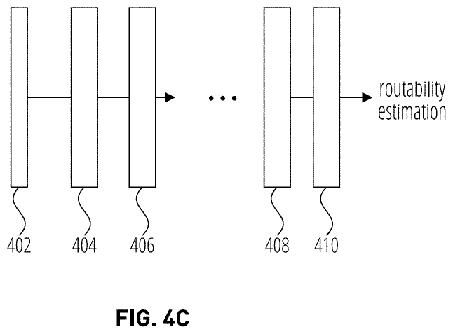

FIG. 4A depicts reinforcement learning logic in one embodiment. As in FIG. 3, nodes i and k are unplaced devices selected from the set of all unplaced devices at a point in the process (there will typically be many additional unplaced device nodes in the graph neural network 302 at a given point in the process). Cross hatched nodes are already placed devices and vertically hatched nodes j and l are the most recently placed PMOS and NMOS device. The symbols hᵢ, hⱼ, hₗ, hₖ represent the graph embeddings computed by the graph neural network. The symbols pᵢ and pⱼ represent the action probabilities for i and j, respectively. The symbol v represents the value estimation of a placed node in the current state. Both of the policy network 304 and the state value network 306 are, in one embodiment, two-layer fully connected neural networks.

A novel application of a continuous kernel-based convolutional operator may be utilized to generate node embeddings on each node of the graph. This convolution kernel aggregates information between nodes of the graph neural network. The convolutional kernel equation is given by:

$${h}_{i}^{′} = ⊖ {h}_{i} + {\sum }_{j ∈ N ( i )} {h}_{j} \cdot {m}_{⊖} {e}_{i , j}$$

where h′ᵢ, and hᵢ are the new and previous embeddings of node i, respectively; h′ₖ and hₖ are the new and previous embeddings of node k, respectively; hⱼ is the previous embedding of node i's neighbor node j; e_{i,j} are features of the edge between nodes i and j; m_{⊖} is a linear network that maps edge feature dimensions to node embedding dimensions; and ⊖ (preceding hᵢ) is another linear network that maps input node embedding dimensions to output node embedding dimensions.

Once the node embedding of the device and pin nodes are established, the RL placer computes the element wise dot (inner) product between the embeddings of unplaced nodes and the most recently placed nodes. These element wise products become the new embeddings of unplaced nodes. A linear network (policy network 304) is utilized on the products to predict the action probability of each (unplaced) node being selected for placement in the next step. These operations provide a probability distribution for selecting the next device pair (and/or pin) to be placed in a manner that is highly correlated to the most recently placed devices. The reward of the RL environment may in one embodiment be derived from the cost function of the simulated annealing method. To minimize the cost, the rewards may be applied as the negative value of the cost function.

To improve the routability of the generated placement, a routability estimation metric may be included in the placement cost function. In one embodiment, a routability prediction for a particular device in the layout is formed by generating a straight routing line from a “left-most” terminal of the device to a “right-most” terminal of the device. “Left-most” and “right-most” refer to positions of the terminals in a horizontal rendering of the layout. Next the routability prediction algorithm computes a maximum and average number of crossing lines on each x (horizontal) location on this straight route that another route can traverse, and generates a weighted average as the routability estimation for the placement. This routability estimation method may produce suitable results, however, there may remain some generated placements that cannot be routed. Those placements may defy routing not because there are not enough wire tracks, but because some terminals of the device are not accessible from a preferred metal routing layer (e.g., the M1 layer). Exemplary pseudocode for such a simple routing estimator is:
Generate straight route from “left-most” terminal of the device to a “right-most” terminal of the device;
Compute maximum and average number of route crossings at each horizontal location on this straight route that another route can cross;
Generate a weighted average of the route crossings as the routability estimation for the placement.

A more sophisticated, machine learning routability estimator may address this issue. With such an algorithm, features are collected for each device pairing on a poly of the layout, such as a number of nets connected to each terminals of the PMOS and NMOS devices, numbers of pins near it, and number of estimated wire crossings over it, etc. The features of all the device pairs are concatenated together into a tensor and a 1D convolution and max pooling applied to predict the routability of the given placement. The routability may be labelled as [routable, routable but with DRCs, not routable], tags that are generated by the router itself. This machine learning algorithm, while offering improvements over the simpler algorithm above, typically will consume more execution resources and slow down the RL placer if executed for each step of the placement. Therefore it may be applied only at particular steps, not all steps, such as steps near the end of the placement generation. An algorithm for a machine-learning routability estimator is thus:
For each poly, form a feature channel of depth M=8: [number of nets connecting to the poly, is PMOS diffusion connected to left side of poly, is NMOS diffusion connected to left side of poly, is PMOS diffusion connected to right side of poly, is NMOS diffusion connected to right side of poly, number of M1 pins to the left of the poly, number of M1 pins to the right of the poly, number of nets that cross the poly];
Construct a tensor for N polys each with channel M;
Apply the tensor to one or more more one-dimensional convolutional layer(s) followed by a maxpool layer to generate predictions of routability as one of: [routable, routable with DRC, unroutable].

An exemplary convolutional neural network to implement such an algorithm is depicted in FIG. 4C, comprising an N sized input tensor 402 of channel depth M input to a first convolution layer 404, followed by a second convolution layer 406 (the number of convolutional layers, and possibly intermediate pooling layers is a design choice), concluding with a maxpool layer 408 and fully connected layer 410 to generate the routability predictions.

FIG. 4B depicts an example of swapping PMOS/NMOS pairs in a layout. Previous placers often separate placement into two steps: pairing and ordering. The pairing step pairs up each PMOS device with a NMOS device to form device pairs. The ordering step generates placement order of device pairs. The final placement can be inferred from placement order and pairs. These two steps are interdependent, so solving one after the other is sub-optimal.

A simulated annealing algorithm that addresses this shortcoming performs pairing and ordering simultaneously. The simulated annealing algorithm may receive pᵢ and pⱼ, the action probabilities for devices i and j in the cell map determined using reinforced learning, and utilize these inputs to make layout decisions. This may accelerate performance of the simulated annealing algorithm.

Simulated annealing makes moves on a placement representation that specify the placement order of pins, ordering of NMOS and PMOS devices, and whether to flip a device orientation (switching the source and drain positions). It optimizes a scoring function that is a weighted sum of cell width, routability estimation and technology constraint violations. These moves can be categorized either by the types of moves or by the targeted devices of the moves. A Flip changes the flip flag of particular devices. A Swap swaps particular devices. A Move moves particular devices to a specific location. The particular devices targeted by these operations may be either consecutive PMOS devices, consecutive NMOS devices, consecutive PMOS/NMOS device pairs, or pins. In one embodiment, the simulated annealing algorithm is implemented based on the modified Lam annealing schedule that requires no hyperparameter tuning.

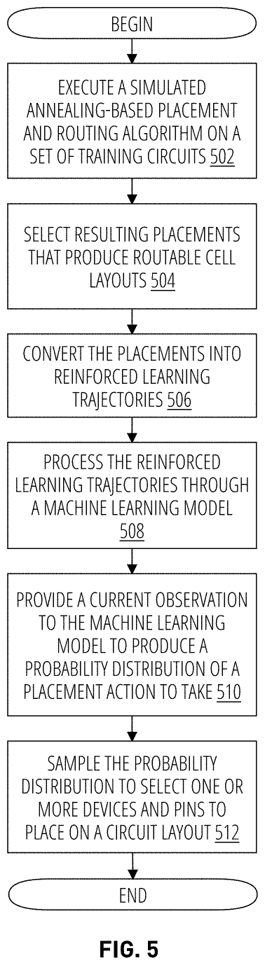

FIG. 5 depicts a circuit element placement process in one embodiment. The process comprises two general stages: training and inference.

A machine learning model is trained by applying behavior cloning from placements of a set of circuits generated by a simulated annealing algorithm. The behavior cloning algorithm may in one embodiment proceed as follows:
1. Execute simulated annealing-based placement and routing on a set of training circuits (block 502); select those placements that produce routable cell layouts (block 504).
2. Convert these placements into RL trajectories (block 506): a set of {observation, action} pairs that correspond to which action (devices, pin to place) to take given an observation (state)
3. Treat the generated RL trajectory set as a supervised learning problem (block 508). The inputs are the observations and targets are actions. The loss function may be cross entropy loss.
4. The machine learning model may be the embodiment depicted in FIG. 4A. The observation is input to the model, and the policy network output (304) may be applied to generate the loss function.

For inference, a current observation (algorithm state) is input to the machine learning model to produce a probability distribution of which action to take at the current step (block 510). The probability distribution is sampled to select an action (block 512; e.g., devices and pin to place). The placement process concludes when all devices and pins of the input net are placed. Multiple inference procedures may be run on each circuit with selection for the final layout being the one that achieved the highest reward in inference.

In another embodiment, a Proximal Policy Optimization (PPO) algorithm may be utilized to train the reinforced learning logic. For example the routeability estimation utilized in the simulated annealing process to generate behavior cloning data may also be applied for PPO training to generate the reward for the reinforced learning algorithm.

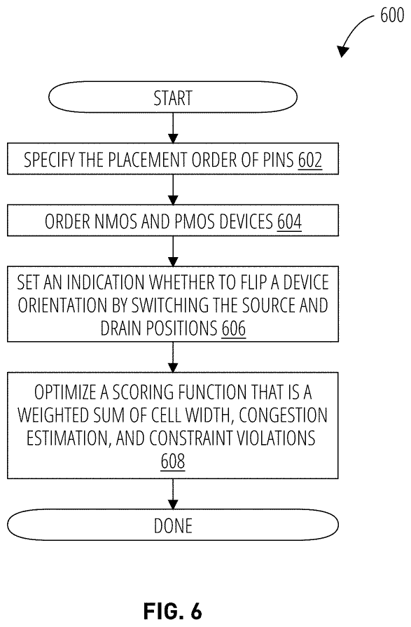

For a set of PMOS and NMOS devices in a standard cell, the placement algorithm strives to place them on the PMOS row and NMOS row of the cell layout while satisfying technology constraints. In addition to device placement, cell pin locations may be specified during placement. Aspects of a placement routine 600 in one embodiment is depicted in FIG. 6.

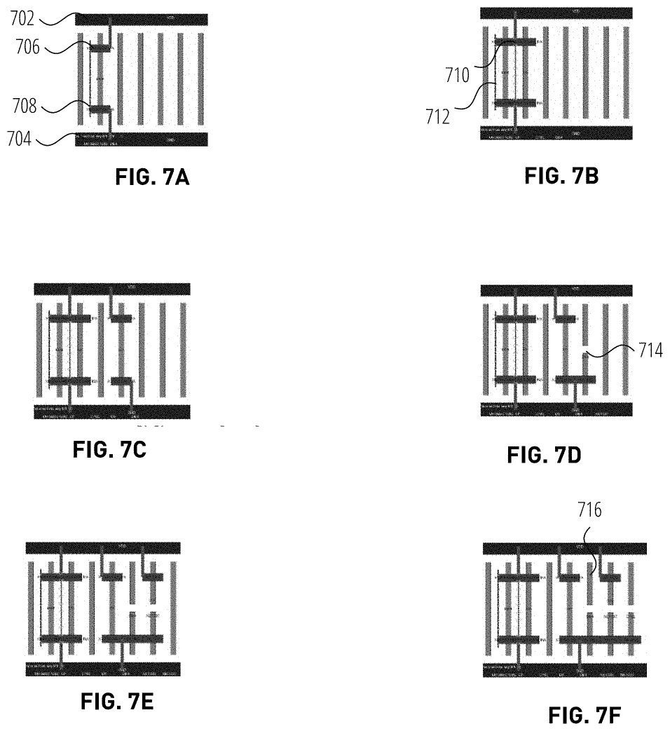

The placement routine 600 may execute moves on a placement template. The moves may specify the placement order of pins (block 602), an order of NMOS and PMOS devices (block 604), and whether to flip a device orientation (switching the source and drain positions —block 606). A scoring function that is a weighted sum of cell width, congestion estimation, and technology constraint violations is optimized (block 608). Moves may be categorized either by the types of the moves (flip, swap, move) or by the targeted devices of the moves. FIG. 7A-FIG. 7F depict an exemplary placement sequence during inference by a reinforcement learning algorithm. Placements of PMOS and NMOS transistors 706, 708 are made along the polys of the standard cell from left to right. On some polys, a dummy device is placed, e.g., dummy PMOS placement 716. On some polys the transistor placements include a shared diffusion region 710, in other places a cut 714 in the poly is inserted. Pin connections 712 are made where appropriate, as well as connections to the power plane 702 and ground plane 704 of the standard cell.

The automated layout algorithms disclosed herein may be utilized along with reinforcement learning (RL) techniques that obviate explicit formulation of DRCs during circuit routing. Constraints are enforced by a reward given in an environment in which DRC analysis is executed independently from routing optimization. Conventional approaches seek to apply reinforcement learning to the routing problem directly, i.e., to cause a reinforcement learning agent to generate routing actions for each wire, where the action space is a routing action (North, South, West, East) for each net of a layout. Instead of making the RL agent learn the job of a maze router, the disclosed techniques learn how to fix DRCs on existing routes. The routing problem is decomposed into two independent steps: routing and DRC fixing. The DRC fixing is configured through reinforced learning and scales to large designs, because DRC problems tend to be local, while routing may utilize global information, especially for long routes.

In one embodiment, an automated layout generator in accordance with the embodiments previously described generates device placements and pin assignments. Device pairing and placement may be performed concurrently. A genetic algorithm based routing flow is then utilized to identify minimum routes and reduce the likelihood of DRC errors. Reinforcement learning is applied to fix DRC errors in the generated routes. Trained on one standard cell, the resulting model may be transferable to others. The model may be further retrained on each cell to improve the results.

In some embodiments, routing may be carried out in two steps: (1) a genetic algorithm-based routing step, and (2) a RL-based DRC fixing step. The genetic algorithm drives a maze router to create a routing candidate set, and the DRC RL agent reduces the number of DRCs of a given routing candidate. The DRC RL agent may for example fix M1 layer DRC errors, and may in some embodiments focus solely on errors in this layer. M1 is the lowest routing layer that typically comprises the most difficult DRC issues. Other DRC errors may be corrected during maze routing. The RL ‘game’ may be configured to incrementally add additional M1 routing segments in order to reduce M1 DRCs. The observation space of the game may include the routes in M1, the DRC positions, and routing mask.

The action space may be set to be the M1 grid to be routed in a next iteration. The rewards for the game may be configured to include a small negative reward given at each step and a large positive reward associated with DRC reduction. A Proximal Policy Optimization (PPO) algorithm may be utilized in one embodiment to implement the RL agent. The policy and value networks for PPO may involve two requirements: invariance as to the number of nets, and invariance as to the cell width, i.e., WM1. Cell height HM1 may typically be constant for a given standard cell library.

The generic algorithm based routing algorithm may utilize routing segments as the genetic representation to facilitate the preservation of well-suited routing islands in the routing structure during genetic operations such as crossover and mutation. The fitness of each individual chromosome in a generation may be evaluated based on two metrics: (1) a number of unrouted terminal pairs, and (2) a number of DRCs. Other metrics may also be configured into the fitness function, such as a total wiring cost or Design For Manufacturing (DFM) metrics.

Therefore, in one aspect, a routing method for a circuit layout disclosed herein utilizes a genetic routing algorithm to generate the candidate routes. A reinforcement learning model is applied to correct design rule constraint errors arising from the routes. Uncorrected design rule constraints from the reinforcement learning model are applied to evolve the genetic routing algorithm, possibly along with other feedback from the RL model, such as a number of unrouted terminal pairs. The routing may be confined to an M1 layer of the circuit layout, although this is not a requirement.

The reinforcement learning model may be implemented in one embodiment with a convolutional neural network generating embeddings for at least one policy neural network and a state value neural network. The convolutional neural network may receive an image of a stick depiction of the circuit layout that the reinforcement learning model transforms into action probabilities (and a state value).

A fitness function for the genetic routing algorithm may utilize a weighted sum of a number of unrouted terminal pairs in the candidate routes and a number of the design rule constraint errors in the candidate routes. Other technical features may be readily apparent to one skilled in the art from the following figures, descriptions, and claims.

Also described herein are embodiments of systems including one or more processors that include logic that when applied to the one or more processors operates a genetic routing algorithm on a circuit layout to generate a plurality of candidate routed circuit layouts, and operates a reinforced learning model to correct design rule constraint errors in the candidate routed circuit layouts. The system may also include feedback from the model of a number of the design rule constraint errors (and a number of unrouted terminal pairs) to evolve the genetic routing algorithm.

The systems may include a number of policy neural networks each including multiple fully connected layers and an operation mask. The state value neural network may also includes multiple fully connected layers. Transformation of the candidate routed circuit layouts into action probabilities and state values may be invariant in relation to a width of the stick depiction.

Artificial neural network embodiments disclosed herein include a convolutional neural network coupled to receive a circuit layout image from a genetic router, the convolutional neural network configured to transform the circuit layout image into embeddings to a plurality of policy neural networks and a state value neural network, the plurality of policy neural networks configured to transform the embeddings into action probabilities for correcting design rule constraint errors in the circuit layout image. Other technical features may be readily apparent to one skilled in the art from the following figures, descriptions, and claims.

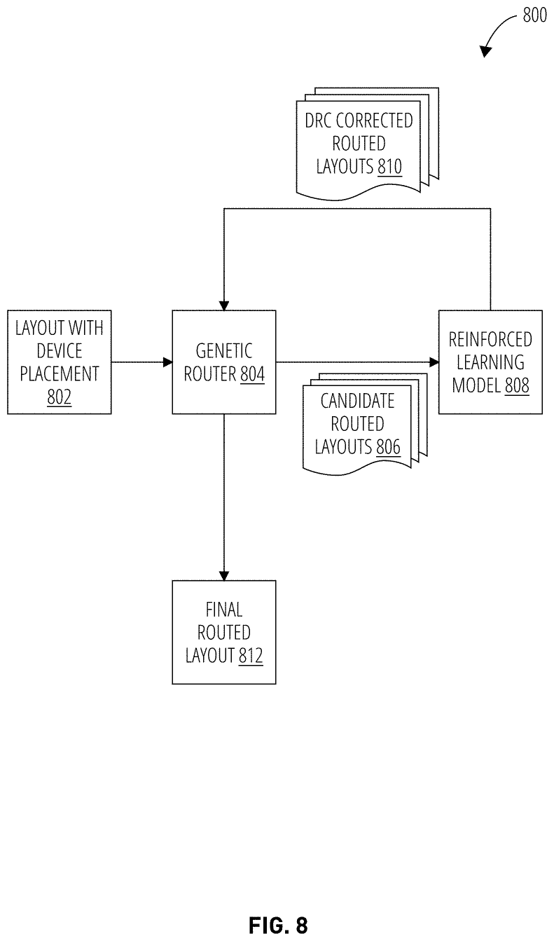

FIG. 8 depicts a circuit layout router 800 in accordance with these principles. A layout with device placement 802 is input to a genetic router 804, which generates a set of candidate routed layouts 806. The candidate routed layouts 806 are applied to a reinforced learning model 808 which corrects DRC errors detected in the candidate routed layouts 806 and returns a set of DRC corrected routed layouts 810 to the genetic router 804. The genetic router 804 evaluates the DRC corrected routed layouts 810 for fitness based, in part, on a number of uncorrected DRC errors remaining in the DRC corrected routed layouts 810. Eventually the genetic router 804 evolves one or more final routed layouts 812.

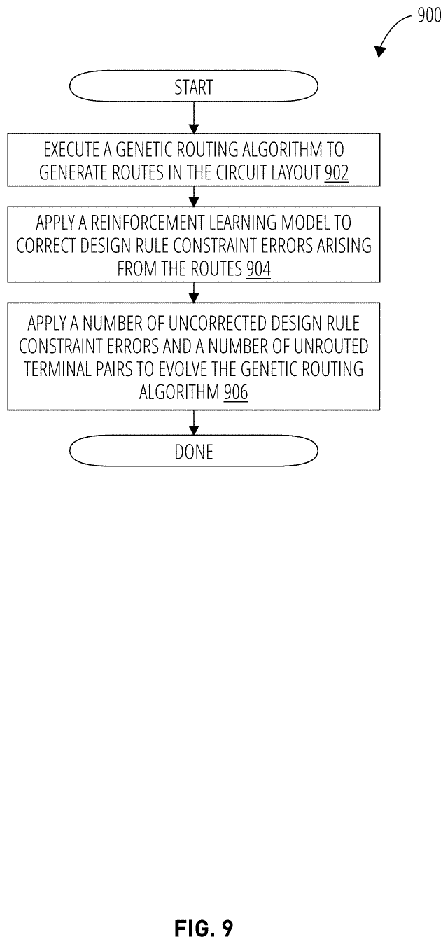

FIG. 9 depicts an incremental routing process 900 for advanced technology nodes in one embodiment. In block 902, the incremental routing process 900 executes a genetic routing algorithm to generate routes in the circuit layout. In block 904, the incremental routing process 900 applies a reinforcement learning model to correct design rule constraint errors arising from the routes. In block 906, the incremental routing process 900 applies the number of uncorrected DRC errors and the number of unrouted terminal pairs in a fitness function to evolve the genetic routing algorithm.

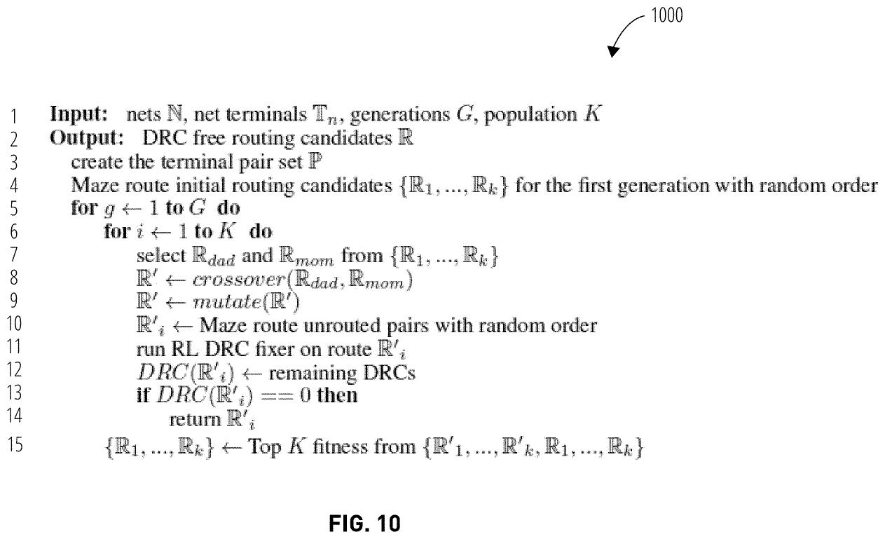

FIG. 10 depicts a genetic routing algorithm 1000 in one embodiment. Inputs to the genetic routing algorithm 1000 include a set N (1 . . . n) of circuit nets and sets of terminals Tₙ for each net n of N. Each Tₙ may be sorted left-to-right or in some other defined order (e.g., right-to-left). If sorted left-to-right, a set of terminal pairs Pₙ may be created for each net n. The union of the sets Pₙ is the global set of terminal pairs P. A “chromosome” in the genetic routing algorithm 1000 represents a possible routing solution. The set of all such chromosomes is a generation G of the genetic routing algorithm 1000. A particular chromosome Rᵢ of G is a set of terminal pairs p from the set P, and a set of (newly generated) routing segments r(p) between those terminal pairs. The routing segments r(p) may in one embodiment be generated utilizing a Lee maze router.

Each chromosome is evaluated according to a fitness function. In one embodiment the fitness function is:

$$f ( {R}_{i} ) = \frac{1}{α U ( {R}_{i} ) + β D R C ( {R}_{i} )}$$

In other words, the fitness is the reciprocal value of a weighted sum of the number of unrouted terminal pairs in Rᵢ (U(Rᵢ)) and a number of remaining DRC errors (DRC(Rᵢ)) in the chromosome (candidate routing solution) after applying reinforcement learning. In one embodiment the weight α is chosen to be larger (e.g., >2×, >3×, >5×, or one or more orders of magnitude greater) than the weight β to prioritize fully routed solutions. Other metrics (e.g., weighted terms) may be also added into this equation, such as total wiring cost or DFM metrics. Because the PPO policy is stochastic, multiple inferences of DRC RL agent on the same route and the final route with the least amount of DRCs then selected as a solution.

A pair of candidate solutions Rₘₒₘ and R_{dad} are selected from a prior generation G for crossover based on a level of fitness. In one embodiment the probability of a chromosome Rᵢ being selected for crossover is given by:

$$\frac{f ( {R}_{i} )}{{\sum }_{i} f ( {R}_{i} )}$$

In other words, candidate solutions with the highest fitness in a generation G are selected for crossover. In one embodiment crossover is carried out as follows:
Select a cut point in the chromosome. The cut can be either vertical or horizontal.
For a vertical cut, the crossover operator takes all the rₘₒₘ(p) routes that lie completely on the left hand side of the vertical cut, and all the r_{dad}(p) routes that lie completely on the right hand side of the cut, and generates a descendant in the next generation from this chromosome pair.
The crossover operator also generates another descendant in the next generation with right side routes from Rₘₒₘ and left side routes from R_{dad}.
A horizontal cut is processed similarly.

For each descendant generated by crossover, a mutation operator may randomly (with a probability of Probₘ) select a region in the candidate layout and remove any routes r(p) in the descendant that touch this region. After mutation, the remaining open terminal pairs may be routed with the maze router using a random terminal pair order.

Both initial routing and subsequent routing of unrouted terminal pairs may be carried out with a maze router that utilizes the grid space of stick representations and a Lee algorithm to search for minimum routes between two terminals. To explore more routing spaces, the maze router may execute a number I>1 iterations and select the solution with a minimum number of unrouted pairs. The maze router may also produce any random route between two terminals with the same cost (weighted routing cost per segment).

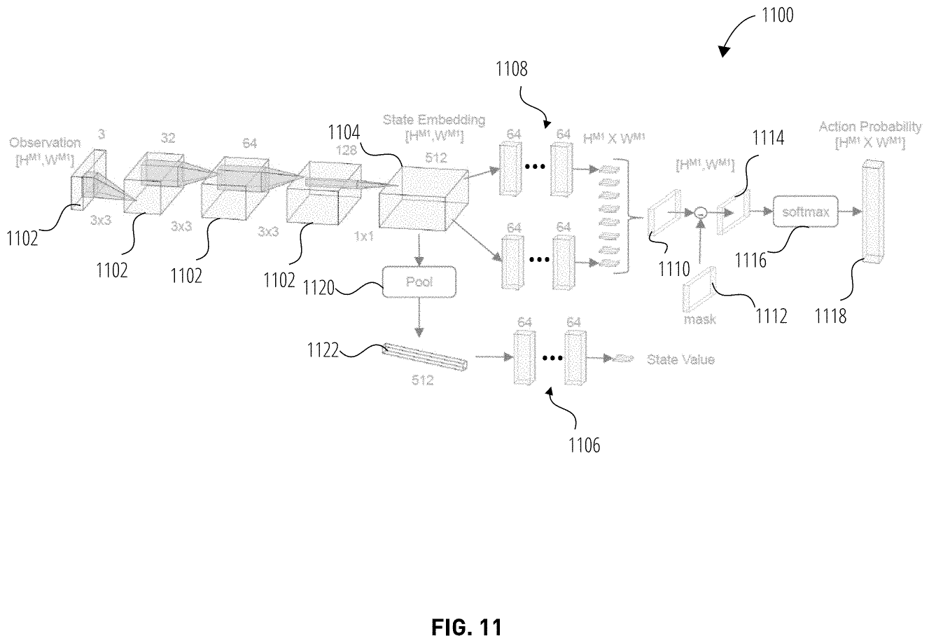

FIG. 11 depicts a reinforcement learning artificial neural network 1100 for DRC error correction in one embodiment. DRC error correction by the reinforcement learning artificial neural network 1100 may be focused in the M1 layer, with DRC errors in other layers being fixed in the routing step. M1 layer DRC errors arise from constraints on cut metal locations. The cut metal locations in turn are inherently determined from the M1 routes. Therefore, changing M1 routes modifies cut metal locations, which in turn change the M1 DRCs. The reinforcement learning may thus be configured to incrementally change the M1 routes in order to reduce M1 DRCs. This methodology may in some embodiments be extended to fix DRCs in other layers as well where incremental changes to the routes is effective in modifying those DRCs.

The reinforcement learning may be configured to restrict the addition of new routes to the M1 layer and not to evaluate the removal of existing M1 routes. This constraint helps ensure the routability of the initial routed solution. It places a limit on the solution space of the DRC fixing step which is ameliorated because the genetic algorithm routing step creates multiple routing solutions that extend the solution space.

A reinforcement learning algorithm may be characterized by its observation space, action space, internal states, reward, and done condition. In one embodiment the internal state of the DRC reinforcement learning environment is the grid space of the stick layout representations. The observation space (obs) is represented in a box tensor of dimensions [3, H^{M1}, W^{M1}]. H^{M1} and W^{M1} are the M1 layer grid dimension. obs[0, :, :] represents the M1 layer routes. obs [1, :, :] represents the routing mask. Two conditions are configured for valid routing grids: (1) they are adjacent to an existing routed grid and (2) they do not create potential shorts to other routes. obs[2, :, :] represents the DRC information.

The action space act is a categorical tensor [H^{M1}×W^{M1}]. It represents the probability of whether any of the M1 layer grid [H^{M1}, W^{M1}] should be routed. The stick representation of the layout is updated according to this action and DRC checker returns any new DRCs that apply after the action.

There are two types of rewards given by the environment. rₛ is a negative reward given at each step. This negative incentive for continuing compels the agent to finish the game as soon as possible. r_{d} is a reward associated with DRC improvement, r_{d}=R_{d}×ΔDRC, where R_{d} is a coefficient and ΔDRC is the reduction of number of DRC errors reported by DRC checker. This reward drives the agent to reduce DRCs as much as possible.

The agent completes its processing under two ‘done’ conditions. First, when there is no available action for the next step, i.e., the mask layer obs [1, :, :]=0. Second, when the number of DRCs is zero, i.e. the DRC layer obs[2, :, :]=0.

In one embodiment a Proximal Policy Optimization (PPO) algorithm is utilized for DRC fixing. The PPO algorithm is a policy gradient based RL algorithm. The PPO algorithm includes two policy models: (1) a training model, and (2) a roll-out model. The training model is responsible for learning model parameters, and the roll-out model is responsible for collecting training data while interacting with the environment.

The PPO algorithm utilizes an objective function that provides limited divergence between the training model and the roll-out model. A deep learning model that utilizes PPO may comprise two subnetworks: (1) a state value subnet that predicts the current state, and (2) a policy subnet that produces the policy probability for each action. These two subnetworks may share a common parent network that generates embeddings applied in each of the separate subnetworks.

A reinforcement learning model for PPO may have two requirements: (1) invariance as to the number of nets, and (2) invariance as to the cell width, i.e., W^{M1}. The cell height H^{M1} is typically a constant for a given technology library. The observation space described above is independent of the number of nets, therefore the first requirement is satisfied. The second requirement, however, is not satisfied by default since the observation space and the action space are both dependent on W^{M1}. The reinforcement learning artificial neural network 1100 embodiment depicted in FIG. 11 eliminates this dependency.

In the depicted reinforcement learning artificial neural network 1100 embodiment, the observation obs (e.g., the stick layout as a two-dimensional digital image) is passed into a number (e.g., four) convolution layers 1102. Each of the convolution layers 1102 may utilize a VALID padding technique (assumes that all the dimensions are valid so that the input image gets fully covered by a filter and the stride) to generate output activations having the same height and width as the input vector. The output of the last convolution layer is the state embedding 1104, which in the depicted embodiment has the tensor [512, H^{M1}, W^{M1}]. The state embedding 1104 is input to both the state value network 1106 and one or more policy networks 1108. The policy networks 1108 depicted each comprise a number of fully connected layers (e.g., three) with channel dimensions (64, 64, 1). Each pixel of the state embedding 1104 may be input to these fully connected layers. Because the channel dimension of each pixel on the state embedding 1104 is fixed (e.g., at 512), the parameters of those fully connected layers are not dependent on the size of the input image. The outputs of the policy networks 1108 for all the H^{M1}×W^{M1} pixels are collected together (collected outputs 1110), masked with the action mask 1112 from the observation into masked outputs 1114, and input to a Softmax layer 1116 to generate the final action policies 1118 vector.

To produce the state value, the state embedding 1104 in this example is input to a pooling layer 1120 (e.g., avgpool) to form a 512 wide vector 1122. This vector 1122 is input to state value network 1106 which comprises a number (e.g., three) of fully connected layers. In the depicted example these layers process vectors with channel dimensions (64, 64, 1). The outputs of the state value network 1106 are the state value predictions. The state value network 1106 is independent of the size of the input stick depiction image.

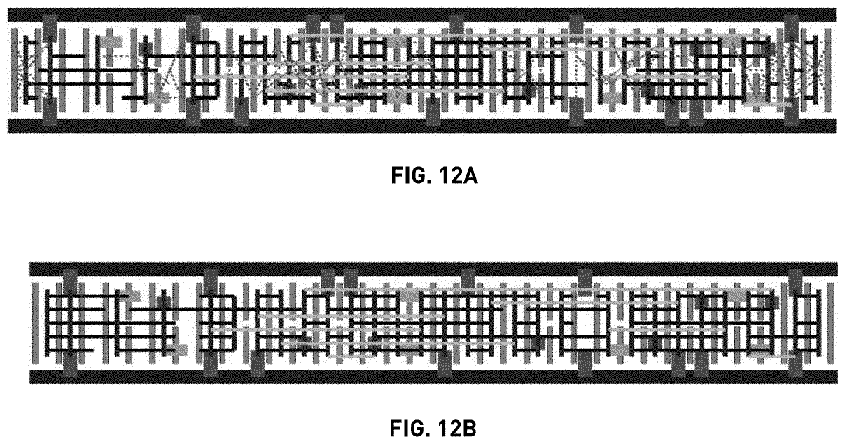

FIG. 12A depicts an exemplary routed layout generated by a DRC configured genetic algorithm. Dotted lines depict M1 layer DRC violations.

FIG. 12B depicts the routed layout of FIG. 12A after DRC fixes are applied by a reinforcement learning algorithm.

The algorithms and techniques disclosed herein may be executed by computing devices utilizing one or more graphic processing unit (GPU) and/or general purpose data processor (e.g., a ‘central processing unit or CPU). Those of ordinary skill in the art will appreciate that certain GPU computing architectures, e.g. as provided by Nvidia Corp®, provide features tailored to implementation of reinforced learning, placement, and routing algorithms. Exemplary architectures will now be described that may be configured to carry out the techniques disclosed herein on such devices.

For example the reinforcement learning algorithm embodiments described herein may be implemented in Python based on the OpenAI GYM framework. The genetic algorithm and maze router may also implemented in Python. Training for the reinforcement learning model may be conducted on a NVIDIA V100 GPU. The genetic routing algorithm may be executed on a NVIDIA DGX server with 64 CPU cores (Intel Xeon CPU E5-2698 v4 @ 2.20 GHz) and 8 V100 GPUs. The hyperparameters of the genetic algorithm may be set as follows: G=200, K=24, Probm=0.01, TR=10, α=100, β=1.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

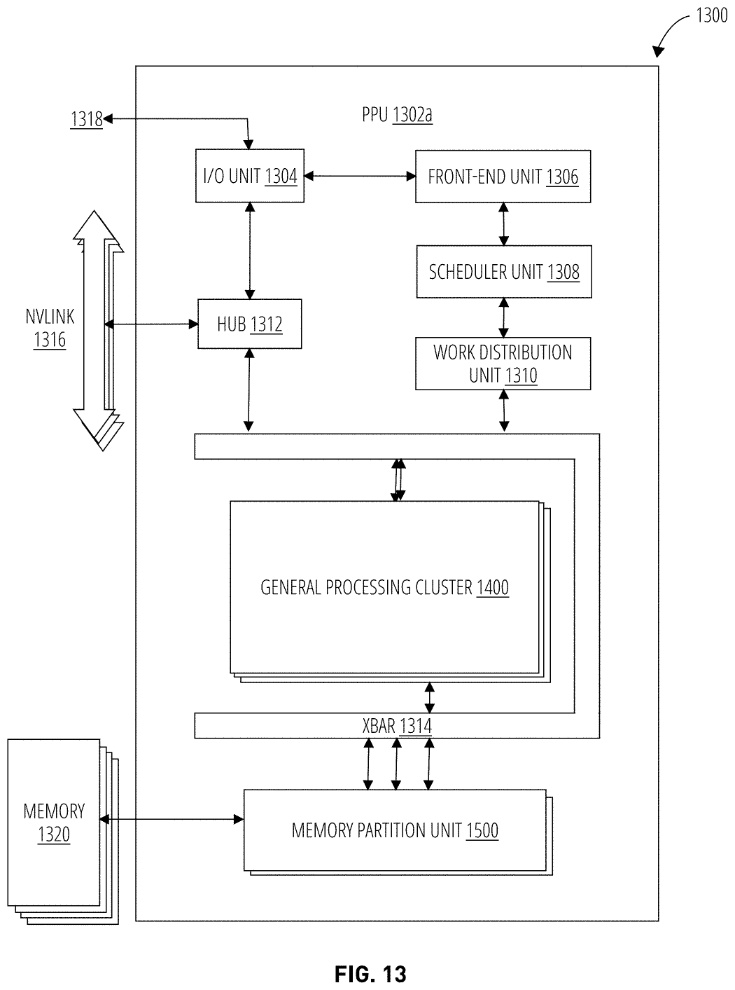

FIG. 13 depicts a computing system 1300 including a parallel processing unit 1302a, in accordance with an embodiment. In an embodiment, the parallel processing unit 1302a is a multi-threaded processor that is implemented on one or more integrated circuit devices. The parallel processing unit 1302a is a latency hiding architecture designed to process many threads in parallel. A thread (e.g., a thread of execution) is an instantiation of a set of instructions configured to be executed by the parallel processing unit 1302a. In an embodiment, the parallel processing unit 1302a is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 1302a may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 1302a modules may be configured to accelerate thousands of High Performance Computing (HPC), data center, and machine learning applications. The parallel processing unit 1302a may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 13, the parallel processing unit 1302a includes an I/O unit 1304, a front-end unit 1306, a scheduler unit 1308, a work distribution unit 1310, a hub 1312, a crossbar 1314, one or more general processing cluster 1400 modules, and one or more memory partition unit 1500 modules. The parallel processing unit 1302a may be connected to a host processor or other parallel processing unit 1302a modules via one or more high-speed NVLink 1316 interconnects. The parallel processing unit 1302a may be connected to a host processor or other peripheral devices via an interconnect 1318. The parallel processing unit 1302a may also be connected to a local memory comprising a number of memory 1320 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 1320 may comprise logic to configure the parallel processing unit 1302a to carry out aspects of the techniques disclosed herein.

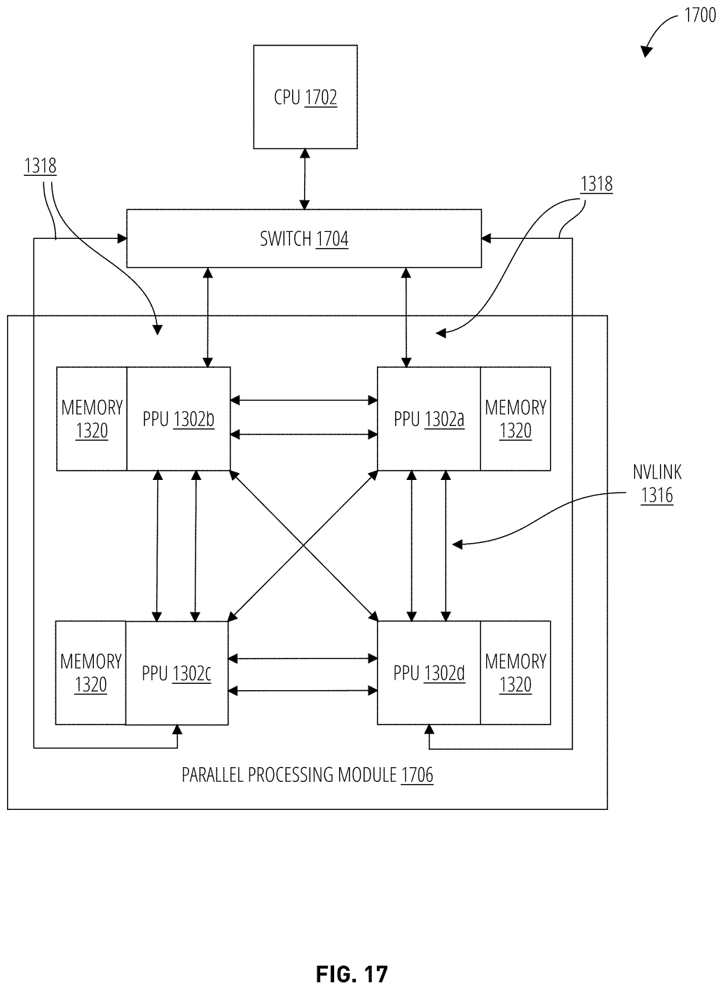

The NVLink 1316 interconnect enables systems to scale and include one or more parallel processing unit 1302a modules combined with one or more CPUs, supports cache coherence between the parallel processing unit 1302a modules and CPUs, and CPU mastering. Data and/or commands may be transmitted by the NVLink 1316 through the hub 1312 to/from other units of the parallel processing unit 1302a such as one or more copy engines, a video encoder, a video decoder, a power management unit, etc. (not explicitly shown). The NVLink 1316 is described in more detail in conjunction with FIG. 17.

The I/O unit 1304 is configured to transmit and receive communications (e.g., commands, data, etc.) from a host processor (not shown) over the interconnect 1318. The I/O unit 1304 may communicate with the host processor directly via the interconnect 1318 or through one or more intermediate devices such as a memory bridge. In an embodiment, the I/O unit 1304 may communicate with one or more other processors, such as one or more parallel processing unit 1302a modules via the interconnect 1318. In an embodiment, the I/O unit 1304 implements a Peripheral Component Interconnect Express (PCIe) interface for communications over a PCIe bus and the interconnect 1318 is a PCIe bus. In alternative embodiments, the I/O unit 1304 may implement other types of well-known interfaces for communicating with external devices.

The I/O unit 1304 decodes packets received via the interconnect 1318. In an embodiment, the packets represent commands configured to cause the parallel processing unit 1302a to perform various operations. The I/O unit 1304 transmits the decoded commands to various other units of the parallel processing unit 1302a as the commands may specify. For example, some commands may be transmitted to the front-end unit 1306. Other commands may be transmitted to the hub 1312 or other units of the parallel processing unit 1302a such as one or more copy engines, a video encoder, a video decoder, a power management unit, etc. (not explicitly shown). In other words, the I/O unit 1304 is configured to route communications between and among the various logical units of the parallel processing unit 1302a.

In an embodiment, a program executed by the host processor encodes a command stream in a buffer that provides workloads to the parallel processing unit 1302a for processing. A workload may comprise several instructions and data to be processed by those instructions. The buffer is a region in a memory that is accessible (e.g., read/write) by both the host processor and the parallel processing unit 1302a. For example, the I/O unit 1304 may be configured to access the buffer in a system memory connected to the interconnect 1318 via memory requests transmitted over the interconnect 1318. In an embodiment, the host processor writes the command stream to the buffer and then transmits a pointer to the start of the command stream to the parallel processing unit 1302a. The front-end unit 1306 receives pointers to one or more command streams. The front-end unit 1306 manages the one or more streams, reading commands from the streams and forwarding commands to the various units of the parallel processing unit 1302a.

The front-end unit 1306 is coupled to a scheduler unit 1308 that configures the various general processing cluster 1400 modules to process tasks defined by the one or more streams. The scheduler unit 1308 is configured to track state information related to the various tasks managed by the scheduler unit 1308. The state may indicate which general processing cluster 1400 a task is assigned to, whether the task is active or inactive, a priority level associated with the task, and so forth. The scheduler unit 1308 manages the execution of a plurality of tasks on the one or more general processing cluster 1400 modules.

The scheduler unit 1308 is coupled to a work distribution unit 1310 that is configured to dispatch tasks for execution on the general processing cluster 1400 modules. The work distribution unit 1310 may track a number of scheduled tasks received from the scheduler unit 1308. In an embodiment, the work distribution unit 1310 manages a pending task pool and an active task pool for each of the general processing cluster 1400 modules. The pending task pool may comprise a number of slots (e.g., 32 slots) that contain tasks assigned to be processed by a particular general processing cluster 1400. The active task pool may comprise a number of slots (e.g., 4 slots) for tasks that are actively being processed by the general processing cluster 1400 modules. As a general processing cluster 1400 finishes the execution of a task, that task is evicted from the active task pool for the general processing cluster 1400 and one of the other tasks from the pending task pool is selected and scheduled for execution on the general processing cluster 1400. If an active task has been idle on the general processing cluster 1400, such as while waiting for a data dependency to be resolved, then the active task may be evicted from the general processing cluster 1400 and returned to the pending task pool while another task in the pending task pool is selected and scheduled for execution on the general processing cluster 1400.

The work distribution unit 1310 communicates with the one or more general processing cluster 1400 modules via crossbar 1314. The crossbar 1314 is an interconnect network that couples many of the units of the parallel processing unit 1302a to other units of the parallel processing unit 1302a. For example, the crossbar 1314 may be configured to couple the work distribution unit 1310 to a particular general processing cluster 1400. Although not shown explicitly, one or more other units of the parallel processing unit 1302a may also be connected to the crossbar 1314 via the hub 1312.

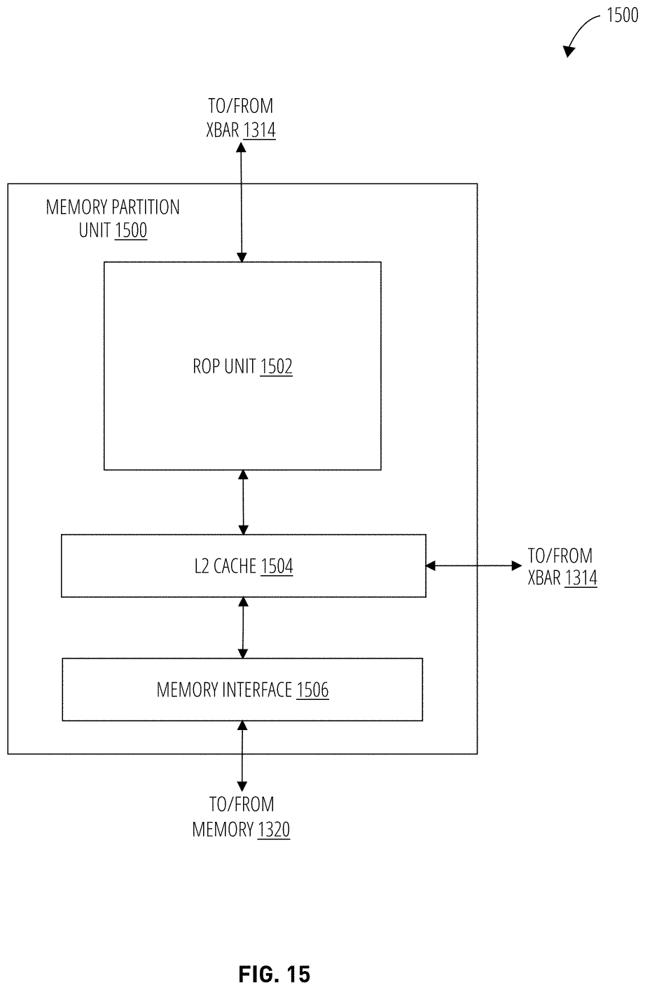

The tasks are managed by the scheduler unit 1308 and dispatched to a general processing cluster 1400 by the work distribution unit 1310. The general processing cluster 1400 is configured to process the task and generate results. The results may be consumed by other tasks within the general processing cluster 1400, routed to a different general processing cluster 1400 via the crossbar 1314, or stored in the memory 1320. The results can be written to the memory 1320 via the memory partition unit 1500 modules, which implement a memory interface for reading and writing data to/from the memory 1320. The results can be transmitted to another parallel processing unit 1302a or CPU via the NVLink 1316. In an embodiment, the parallel processing unit 1302a includes a number U of memory partition unit 1500 modules that is equal to the number of separate and distinct memory 1320 devices coupled to the parallel processing unit 1302a. A memory partition unit 1500 will be described in more detail below in conjunction with FIG. 15.

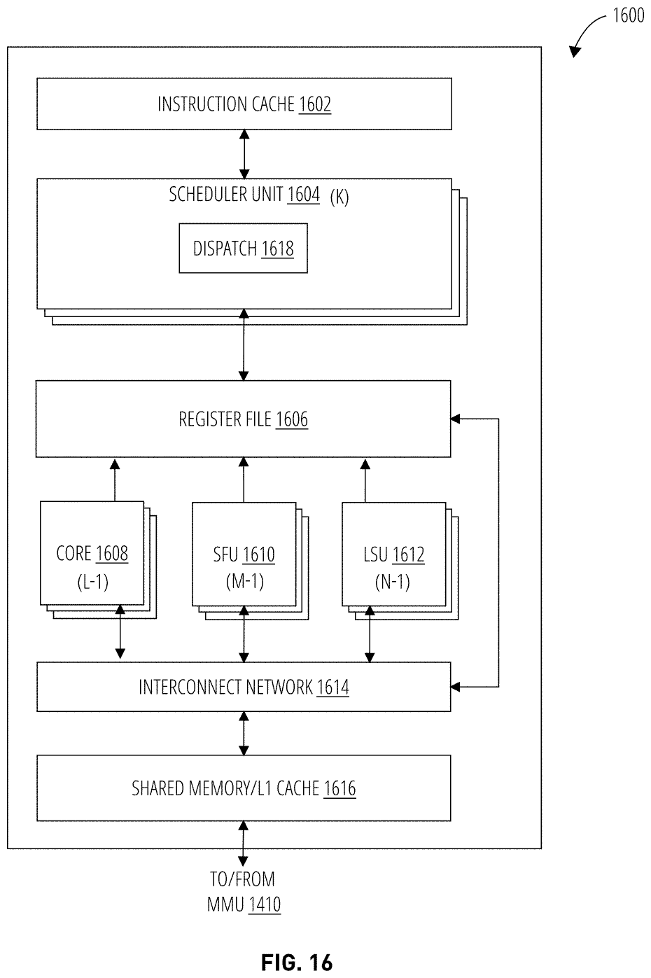

In an embodiment, a host processor executes a driver kernel that implements an application programming interface (API) that enables one or more applications executing on the host processor to schedule operations for execution on the parallel processing unit 1302a. In an embodiment, multiple compute applications are simultaneously executed by the parallel processing unit 1302a and the parallel processing unit 1302a provides isolation, quality of service (QoS), and independent address spaces for the multiple compute applications. An application may generate instructions (e.g., API calls) that cause the driver kernel to generate one or more tasks for execution by the parallel processing unit 1302a. The driver kernel outputs tasks to one or more streams being processed by the parallel processing unit 1302a. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 16.

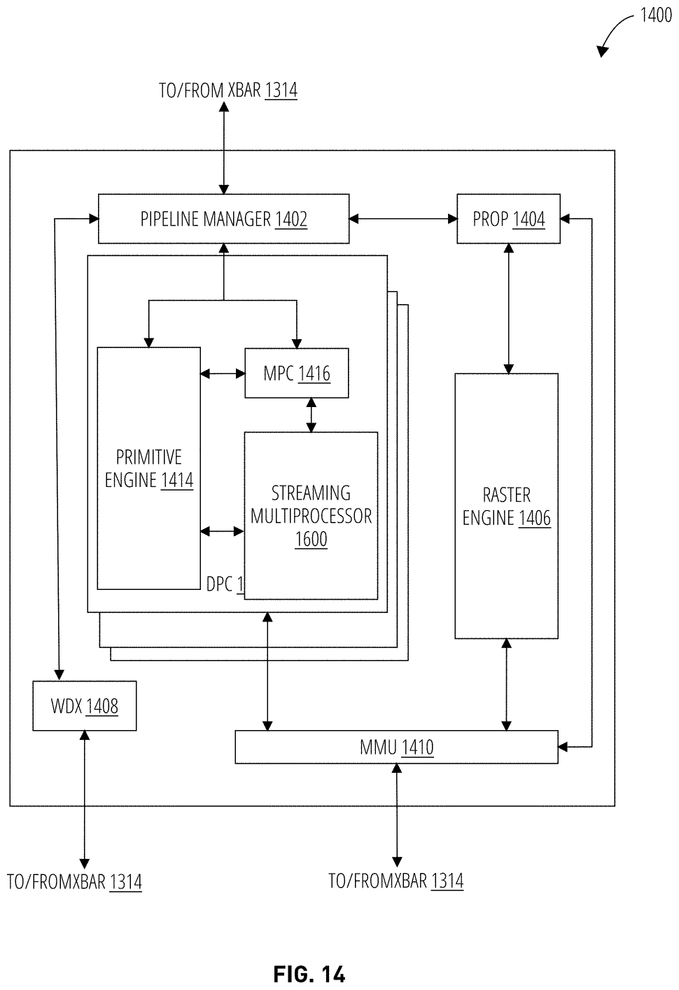

FIG. 14 depicts a general processing cluster 1400 of the parallel processing unit 1302a of FIG. 13, in accordance with an embodiment. As shown in FIG. 14, each general processing cluster 1400 includes a number of hardware units for processing tasks. In an embodiment, each general processing cluster 1400 includes a pipeline manager 1402, a pre-raster operations unit 1404, a raster engine 1406, a work distribution crossbar 1408, a memory management unit 1410, and one or more data processing cluster 1412. It will be appreciated that the general processing cluster 1400 of FIG. 14 may include other hardware units in lieu of or in addition to the units shown in FIG. 14.

In an embodiment, the operation of the general processing cluster 1400 is controlled by the pipeline manager 1402. The pipeline manager 1402 manages the configuration of the one or more data processing cluster 1412 modules for processing tasks allocated to the general processing cluster 1400. In an embodiment, the pipeline manager 1402 may configure at least one of the one or more data processing cluster 1412 modules to implement at least a portion of a graphics rendering pipeline. For example, a data processing cluster 1412 may be configured to execute a vertex shader program on the programmable streaming multiprocessor 1600. The pipeline manager 1402 may also be configured to route packets received from the work distribution unit 1310 to the appropriate logical units within the general processing cluster 1400. For example, some packets may be routed to fixed function hardware units in the pre-raster operations unit 1404 and/or raster engine 1406 while other packets may be routed to the data processing cluster 1412 modules for processing by the primitive engine 1414 or the streaming multiprocessor 1600. In an embodiment, the pipeline manager 1402 may configure at least one of the one or more data processing cluster 1412 modules to implement a neural network model and/or a computing pipeline.

The pre-raster operations unit 1404 is configured to route data generated by the raster engine 1406 and the data processing cluster 1412 modules to a Raster Operations (ROP) unit, described in more detail in conjunction with FIG. 15. The pre-raster operations unit 1404 may also be configured to perform optimizations for color blending, organize pixel data, perform address translations, and the like.

The raster engine 1406 includes a number of fixed function hardware units configured to perform various raster operations. In an embodiment, the raster engine 1406 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1406 comprises fragments to be processed, for example, by a fragment shader implemented within a data processing cluster 1412.

Each data processing cluster 1412 included in the general processing cluster 1400 includes an M-pipe controller 1416, a primitive engine 1414, and one or more streaming multiprocessor 1600 modules. The M-pipe controller 1416 controls the operation of the data processing cluster 1412, routing packets received from the pipeline manager 1402 to the appropriate units in the data processing cluster 1412. For example, packets associated with a vertex may be routed to the primitive engine 1414, which is configured to fetch vertex attributes associated with the vertex from the memory 1320. In contrast, packets associated with a shader program may be transmitted to the streaming multiprocessor 1600.

The streaming multiprocessor 1600 comprises a programmable streaming processor that is configured to process tasks represented by a number of threads. Each streaming multiprocessor 1600 is multi-threaded and configured to execute a plurality of threads (e.g., 32 threads) from a particular group of threads concurrently. In an embodiment, the streaming multiprocessor 1600 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1600 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1600 will be described in more detail below in conjunction with FIG. 16.

The memory management unit 1410 provides an interface between the general processing cluster 1400 and the memory partition unit 1500. The memory management unit 1410 may provide translation of virtual addresses into physical addresses, memory protection, and arbitration of memory requests. In an embodiment, the memory management unit 1410 provides one or more translation lookaside buffers (TLBs) for performing translation of virtual addresses into physical addresses in the memory 1320.

FIG. 15 depicts a memory partition unit 1500 of the parallel processing unit 1302a of FIG. 13, in accordance with an embodiment. As shown in FIG. 15, the memory partition unit 1500 includes a raster operations unit 1502, a level two cache 1504, and a memory interface 1506. The memory interface 1506 is coupled to the memory 1320. Memory interface 1506 may implement 32, 64, 128, 1024-bit data buses, or the like, for high-speed data transfer. In an embodiment, the parallel processing unit 1302a incorporates U memory interface 1506 modules, one memory interface 1506 per pair of memory partition unit 1500 modules, where each pair of memory partition unit 1500 modules is connected to a corresponding memory 1320 device. For example, parallel processing unit 1302a may be connected to up to Y memory 1320 devices, such as high bandwidth memory stacks or graphics double-data-rate, version 5, synchronous dynamic random access memory, or other types of persistent storage.

In an embodiment, the memory interface 1506 implements an HBM2 memory interface and Y equals half U. In an embodiment, the HBM2 memory stacks are located on the same physical package as the parallel processing unit 1302a, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1320 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 1302a modules process very large datasets and/or run applications for extended periods.

In an embodiment, the parallel processing unit 1302a implements a multi-level memory hierarchy. In an embodiment, the memory partition unit 1500 supports a unified memory to provide a single unified virtual address space for CPU and parallel processing unit 1302a memory, enabling data sharing between virtual memory systems. In an embodiment the frequency of accesses by a parallel processing unit 1302a to memory located on other processors is traced to ensure that memory pages are moved to the physical memory of the parallel processing unit 1302a that is accessing the pages more frequently. In an embodiment, the NVLink 1316 supports address translation services allowing the parallel processing unit 1302a to directly access a CPU's page tables and providing full access to CPU memory by the parallel processing unit 1302a.

In an embodiment, copy engines transfer data between multiple parallel processing unit 1302a modules or between parallel processing unit 1302a modules and CPUs. The copy engines can generate page faults for addresses that are not mapped into the page tables. The memory partition unit 1500 can then service the page faults, mapping the addresses into the page table, after which the copy engine can perform the transfer. In a conventional system, memory is pinned (e.g., non-pageable) for multiple copy engine operations between multiple processors, reducing the available memory. With hardware page faulting, addresses can be passed to the copy engines without worrying if the memory pages are resident, and the copy process is transparent.

Data from the memory 1320 or other system memory may be fetched by the memory partition unit 1500 and stored in the level two cache 1504, which is located on-chip and is shared between the various general processing cluster 1400 modules. As shown, each memory partition unit 1500 includes a portion of the level two cache 1504 associated with a corresponding memory 1320 device. Lower level caches may then be implemented in various units within the general processing cluster 1400 modules. For example, each of the streaming multiprocessor 1600 modules may implement an L1 cache. The L1 cache is private memory that is dedicated to a particular streaming multiprocessor 1600. Data from the level two cache 1504 may be fetched and stored in each of the L1 caches for processing in the functional units of the streaming multiprocessor 1600 modules. The level two cache 1504 is coupled to the memory interface 1506 and the crossbar 1314.

The raster operations unit 1502 performs graphics raster operations related to pixel color, such as color compression, pixel blending, and the like. The raster operations unit 1502 also implements depth testing in conjunction with the raster engine 1406, receiving a depth for a sample location associated with a pixel fragment from the culling engine of the raster engine 1406. The depth is tested against a corresponding depth in a depth buffer for a sample location associated with the fragment. If the fragment passes the depth test for the sample location, then the raster operations unit 1502 updates the depth buffer and transmits a result of the depth test to the raster engine 1406. It will be appreciated that the number of partition memory partition unit 1500 modules may be different than the number of general processing cluster 1400 modules and, therefore, each raster operations unit 1502 may be coupled to each of the general processing cluster 1400 modules. The raster operations unit 1502 tracks packets received from the different general processing cluster 1400 modules and determines which general processing cluster 1400 that a result generated by the raster operations unit 1502 is routed to through the crossbar 1314. Although the raster operations unit 1502 is included within the memory partition unit 1500 in FIG. 15, in other embodiment, the raster operations unit 1502 may be outside of the memory partition unit 1500. For example, the raster operations unit 1502 may reside in the general processing cluster 1400 or another unit.

FIG. 16 illustrates the streaming multiprocessor 1600 of FIG. 14, in accordance with an embodiment. As shown in FIG. 16, the streaming multiprocessor 1600 includes an instruction cache 1602, one or more scheduler unit 1604 modules (e.g., such as scheduler unit 1308), a register file 1606, one or more processing core 1608 modules, one or more special function unit 1610 modules, one or more load/store unit 1612 modules, an interconnect network 1614, and a shared memory/L1 cache 1616.

As described above, the work distribution unit 1310 dispatches tasks for execution on the general processing cluster 1400 modules of the parallel processing unit 1302a. The tasks are allocated to a particular data processing cluster 1412 within a general processing cluster 1400 and, if the task is associated with a shader program, the task may be allocated to a streaming multiprocessor 1600. The scheduler unit 1308 receives the tasks from the work distribution unit 1310 and manages instruction scheduling for one or more thread blocks assigned to the streaming multiprocessor 1600. The scheduler unit 1604 schedules thread blocks for execution as warps of parallel threads, where each thread block is allocated at least one warp. In an embodiment, each warp executes 32 threads. The scheduler unit 1604 may manage a plurality of different thread blocks, allocating the warps to the different thread blocks and then dispatching instructions from the plurality of different cooperative groups to the various functional units (e.g., core 1608 modules, special function unit 1610 modules, and load/store unit 1612 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1618 unit is configured within the scheduler unit 1604 to transmit instructions to one or more of the functional units. In one embodiment, the scheduler unit 1604 includes two dispatch 1618 units that enable two different instructions from the same warp to be dispatched during each clock cycle. In alternative embodiments, each scheduler unit 1604 may include a single dispatch 1618 unit or additional dispatch 1618 units.

Each streaming multiprocessor 1600 includes a register file 1606 that provides a set of registers for the functional units of the streaming multiprocessor 1600. In an embodiment, the register file 1606 is divided between each of the functional units such that each functional unit is allocated a dedicated portion of the register file 1606. In another embodiment, the register file 1606 is divided between the different warps being executed by the streaming multiprocessor 1600. The register file 1606 provides temporary storage for operands connected to the data paths of the functional units.

Each streaming multiprocessor 1600 comprises L processing core 1608 modules. In an embodiment, the streaming multiprocessor 1600 includes a large number (e.g., 128, etc.) of distinct processing core 1608 modules. Each core 1608 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1608 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1608 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply involves 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1600 also comprises M special function unit 1610 modules that perform special functions (e.g., attribute evaluation, reciprocal square root, and the like). In an embodiment, the special function unit 1610 modules may include a tree traversal unit configured to traverse a hierarchical tree data structure. In an embodiment, the special function unit 1610 modules may include texture unit configured to perform texture map filtering operations. In an embodiment, the texture units are configured to load texture maps (e.g., a 2D array of texels) from the memory 1320 and sample the texture maps to produce sampled texture values for use in shader programs executed by the streaming multiprocessor 1600. In an embodiment, the texture maps are stored in the shared memory/L1 cache 1616. The texture units implement texture operations such as filtering operations using mip-maps (e.g., texture maps of varying levels of detail). In an embodiment, each streaming multiprocessor 1600 includes two texture units.

Each streaming multiprocessor 1600 also comprises N load/store unit 1612 modules that implement load and store operations between the shared memory/L1 cache 1616 and the register file 1606. Each streaming multiprocessor 1600 includes an interconnect network 1614 that connects each of the functional units to the register file 1606 and the load/store unit 1612 to the register file 1606 and shared memory/L1 cache 1616. In an embodiment, the interconnect network 1614 is a crossbar that can be configured to connect any of the functional units to any of the registers in the register file 1606 and connect the load/store unit 1612 modules to the register file 1606 and memory locations in shared memory/L1 cache 1616.

The shared memory/L1 cache 1616 is an array of on-chip memory that allows for data storage and communication between the streaming multiprocessor 1600 and the primitive engine 1414 and between threads in the streaming multiprocessor 1600. In an embodiment, the shared memory/L1 cache 1616 comprises 128 KB of storage capacity and is in the path from the streaming multiprocessor 1600 to the memory partition unit 1500. The shared memory/L1 cache 1616 can be used to cache reads and writes. One or more of the shared memory/L1 cache 1616, level two cache 1504, and memory 1320 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1616 enables the shared memory/L1 cache 1616 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 13, are bypassed, creating a much simpler programming model. In the general purpose parallel computation configuration, the work distribution unit 1310 assigns and distributes blocks of threads directly to the data processing cluster 1412 modules. The threads in a block execute the same program, using a unique thread ID in the calculation to ensure each thread generates unique results, using the streaming multiprocessor 1600 to execute the program and perform calculations, shared memory/L1 cache 1616 to communicate between threads, and the load/store unit 1612 to read and write global memory through the shared memory/L1 cache 1616 and the memory partition unit 1500. When configured for general purpose parallel computation, the streaming multiprocessor 1600 can also write commands that the scheduler unit 1308 can use to launch new work on the data processing cluster 1412 modules.

The parallel processing unit 1302a may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 1302a is embodied on a single semiconductor substrate. In another embodiment, the parallel processing unit 1302a is included in a system-on-a-chip (SoC) along with one or more other devices such as additional parallel processing unit 1302a modules, the memory 1320, a reduced instruction set computer (RISC) CPU, a memory management unit (MMU), a digital-to-analog converter (DAC), and the like.

In an embodiment, the parallel processing unit 1302a may be included on a graphics card that includes one or more memory devices. The graphics card may be configured to interface with a PCIe slot on a motherboard of a desktop computer. In yet another embodiment, the parallel processing unit 1302a may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 17 is a conceptual diagram of a processing system 1700 implemented using the parallel processing unit 1302a of FIG. 13, in accordance with an embodiment. The processing system 1700 includes a central processing unit 1702, switch 1704, and multiple parallel processing units 1302a, 1302b, 1302c, 1302d each with respective memory 1320 modules. The NVLink 1316 provides high-speed communication links between each of the parallel processing unit 1302a modules. Although a particular number of NVLink 1316 and interconnect 1318 connections are illustrated in FIG. 17, the number of connections to each parallel processing unit 1302a and the central processing unit 1702 may vary. The switch 1704 interfaces between the interconnect 1318 and the central processing unit 1702. The parallel processing unit 1302a modules, memory 1320 modules, and NVLink 1316 connections may be situated on a single semiconductor platform to form a parallel processing module 1706. In an embodiment, the switch 1704 supports two or more protocols to interface between various different connections and/or links.

In another embodiment (not shown), the NVLink 1316 provides one or more high-speed communication links between each of the parallel processing unit modules (parallel processing unit 1302b, parallel processing unit 1302a, parallel processing unit 1302a, and parallel processing unit 1302c) and the central processing unit 1702 and the switch 1704 interfaces between the interconnect 1318 and each of the parallel processing unit modules. The parallel processing unit modules, memory 1320 modules, and interconnect 1318 may be situated on a single semiconductor platform to form a parallel processing module 1706. In yet another embodiment (not shown), the interconnect 1318 provides one or more communication links between each of the parallel processing unit modules and the central processing unit 1702 and the switch 1704 interfaces between each of the parallel processing unit modules using the NVLink 1316 to provide one or more high-speed communication links between the parallel processing unit modules. In another embodiment (not shown), the NVLink 1316 provides one or more high-speed communication links between the parallel processing unit modules and the central processing unit 1702 through the switch 1704. In yet another embodiment (not shown), the interconnect 1318 provides one or more communication links between each of the parallel processing unit modules directly. One or more of the NVLink 1316 high-speed communication links may be implemented as a physical NVLink interconnect or either an on-chip or on-die interconnect using the same protocol as the NVLink 1316.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1706 may be implemented as a circuit board substrate and each of the parallel processing unit modules and/or memory 1320 modules may be packaged devices. In an embodiment, the central processing unit 1702, switch 1704, and the parallel processing module 1706 are situated on a single semiconductor platform.

In an embodiment, the signaling rate of each NVLink 1316 is 20 to 25 Gigabits/second and each parallel processing unit module includes six NVLink 1316 interfaces (as shown in FIG. 17, five NVLink 1316 interfaces are included for each parallel processing unit module). Each NVLink 1316 provides a data transfer rate of 25 Gigabytes/second in each direction, with six links providing 800 Gigabytes/second. The NVLink 1316 can be used exclusively for PPU-to-PPU communication as shown in FIG. 17, or some combination of PPU-to-PPU and PPU-to-CPU, when the central processing unit 1702 also includes one or more NVLink 1316 interfaces.

In an embodiment, the NVLink 1316 allows direct load/store/atomic access from the central processing unit 1702 to each parallel processing unit module's memory 1320. In an embodiment, the NVLink 1316 supports coherency operations, allowing data read from the memory 1320 modules to be stored in the cache hierarchy of the central processing unit 1702, reducing cache access latency for the central processing unit 1702. In an embodiment, the NVLink 1316 includes support for Address Translation Services (ATS), enabling the parallel processing unit module to directly access page tables within the central processing unit 1702. One or more of the NVLink 1316 may also be configured to operate in a low-power mode.

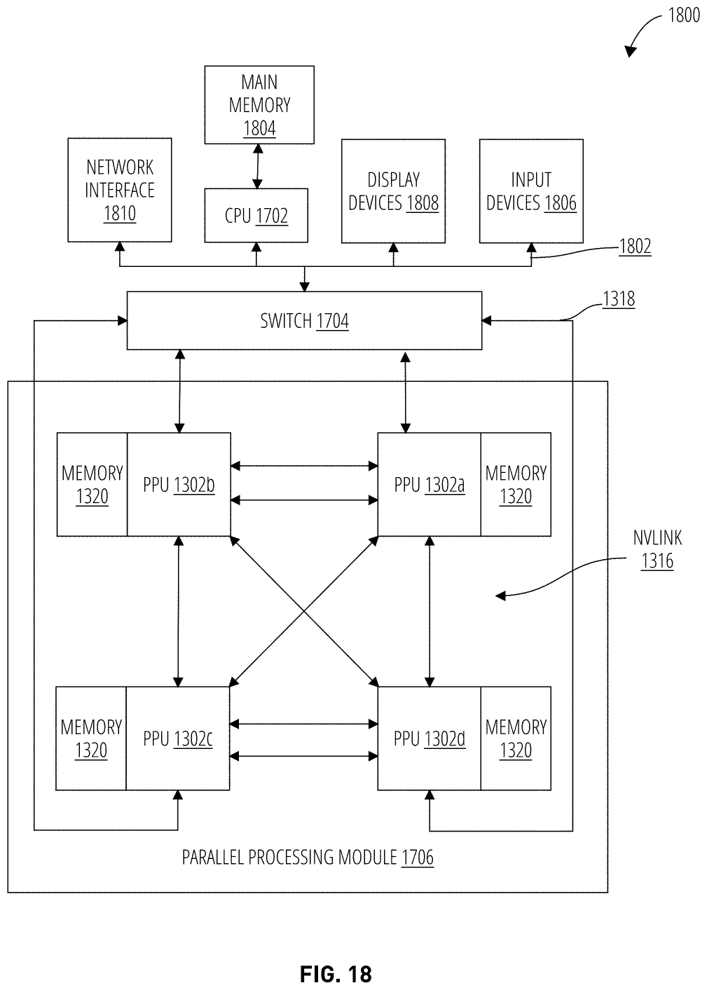

FIG. 18 depicts an exemplary processing system 1800 in which the various architecture and/or functionality of the various previous embodiments may be implemented. As shown, an exemplary processing system 1800 is provided including at least one central processing unit 1702 that is connected to a communications bus 1802. The communication communications bus 1802 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1800 also includes a main memory 1804. Control logic (software) and data are stored in the main memory 1804 which may take the form of random access memory (RAM).

The exemplary processing system 1800 also includes input devices 1806, the parallel processing module 1706, and display devices 1808, e.g. a conventional CRT (cathode ray tube), LCD (liquid crystal display), LED (light emitting diode), plasma display or the like. User input may be received from the input devices 1806, e.g., keyboard, mouse, touchpad, microphone, and the like. Each of the foregoing modules and/or devices may even be situated on a single semiconductor platform to form the exemplary processing system 1800. Alternately, the various modules may also be situated separately or in various combinations of semiconductor platforms per the desires of the user.

Further, the exemplary processing system 1800 may be coupled to a network (e.g., a telecommunications network, local area network (LAN), wireless network, wide area network (WAN) such as the Internet, peer-to-peer network, cable network, or the like) through a network interface 1810 for communication purposes.

The exemplary processing system 1800 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1804 and/or the secondary storage. Such computer programs, when executed, enable the exemplary processing system 1800 to perform various functions. The main memory 1804, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1800 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described, it should be understood that they have been presented by way of example, and not limitation. Thus, the breadth and scope of an embodiment should not be limited by any of the above-described exemplary embodiments, but should be defined in accordance with the following claims and their equivalents.

### Graphics Processing Pipeline

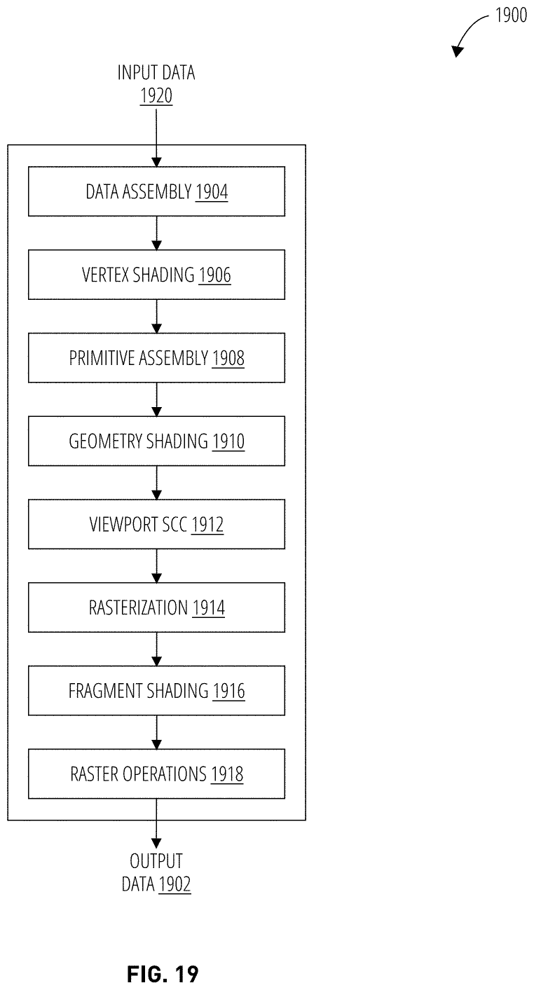

FIG. 19 is a conceptual diagram of a graphics processing pipeline 1900 implemented by the parallel processing unit 1302a of FIG. 13, in accordance with an embodiment. In an embodiment, the parallel processing unit 1302a comprises a graphics processing unit (GPU). The parallel processing unit 1302a is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 1302a can be configured to process the graphics primitives to generate a frame buffer (e.g., pixel data for each of the pixels of the display).

An application writes model data for a scene (e.g., a collection of vertices and attributes) to a memory such as a system memory or memory 1320. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 1600 modules of the parallel processing unit 1302a including one or more of a vertex shader, hull shader, domain shader, geometry shader, and a pixel shader. For example, one or more of the streaming multiprocessor 1600 modules may be configured to execute a vertex shader program that processes a number of vertices defined by the model data. In an embodiment, the different streaming multiprocessor 1600 modules may be configured to execute different shader programs concurrently. For example, a first subset of streaming multiprocessor 1600 modules may be configured to execute a vertex shader program while a second subset of streaming multiprocessor 1600 modules may be configured to execute a pixel shader program. The first subset of streaming multiprocessor 1600 modules processes vertex data to produce processed vertex data and writes the processed vertex data to the level two cache 1504 and/or the memory 1320. After the processed vertex data is rasterized (e.g., transformed from three-dimensional data into two-dimensional data in screen space) to produce fragment data, the second subset of streaming multiprocessor 1600 modules executes a pixel shader to produce processed fragment data, which is then blended with other processed fragment data and written to the frame buffer in memory 1320. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1900 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1900 receives input data 601 that is transmitted from one stage to the next stage of the graphics processing pipeline 1900 to generate output data 1902. In an embodiment, the graphics processing pipeline 1900 may represent a graphics processing pipeline defined by the OpenGL® API. As an option, the graphics processing pipeline 1900 may be implemented in the context of the functionality and architecture of the previous Figures and/or any subsequent Figure(s).

As shown in FIG. 19, the graphics processing pipeline 1900 comprises a pipeline architecture that includes a number of stages. The stages include, but are not limited to, a data assembly 1904 stage, a vertex shading 1906 stage, a primitive assembly 1908 stage, a geometry shading 1910 stage, a viewport SCC 1912 stage, a rasterization 1914 stage, a fragment shading 1916 stage, and a raster operations 1918 stage. In an embodiment, the input data 1920 comprises commands that configure the processing units to implement the stages of the graphics processing pipeline 1900 and geometric primitives (e.g., points, lines, triangles, quads, triangle strips or fans, etc.) to be processed by the stages. The output data 1902 may comprise pixel data (e.g., color data) that is copied into a frame buffer or other type of surface data structure in a memory.

The data assembly 1904 stage receives the input data 1920 that specifies vertex data for high-order surfaces, primitives, or the like. The data assembly 1904 stage collects the vertex data in a temporary storage or queue, such as by receiving a command from the host processor that includes a pointer to a buffer in memory and reading the vertex data from the buffer. The vertex data is then transmitted to the vertex shading 1906 stage for processing.

The vertex shading 1906 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1906 stage may manipulate individual vertex attributes such as position, color, texture coordinates, and the like. In other words, the vertex shading 1906 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1906 stage generates transformed vertex data that is transmitted to the primitive assembly 1908 stage.

The primitive assembly 1908 stage collects vertices output by the vertex shading 1906 stage and groups the vertices into geometric primitives for processing by the geometry shading 1910 stage. For example, the primitive assembly 1908 stage may be configured to group every three consecutive vertices as a geometric primitive (e.g., a triangle) for transmission to the geometry shading 1910 stage. In some embodiments, specific vertices may be reused for consecutive geometric primitives (e.g., two consecutive triangles in a triangle strip may share two vertices). The primitive assembly 1908 stage transmits geometric primitives (e.g., a collection of associated vertices) to the geometry shading 1910 stage.

The geometry shading 1910 stage processes geometric primitives by performing a set of operations (e.g., a geometry shader or program) on the geometric primitives. Tessellation operations may generate one or more geometric primitives from each geometric primitive. In other words, the geometry shading 1910 stage may subdivide each geometric primitive into a finer mesh of two or more geometric primitives for processing by the rest of the graphics processing pipeline 1900. The geometry shading 1910 stage transmits geometric primitives to the viewport SCC 1912 stage.

In an embodiment, the graphics processing pipeline 1900 may operate within a streaming multiprocessor and the vertex shading 1906 stage, the primitive assembly 1908 stage, the geometry shading 1910 stage, the fragment shading 1916 stage, and/or hardware/software associated therewith, may sequentially perform processing operations. Once the sequential processing operations are complete, in an embodiment, the viewport SCC 1912 stage may utilize the data. In an embodiment, primitive data processed by one or more of the stages in the graphics processing pipeline 1900 may be written to a cache (e.g. L1 cache, a vertex cache, etc.). In this case, in an embodiment, the viewport SCC 1912 stage may access the data in the cache. In an embodiment, the viewport SCC 1912 stage and the rasterization 1914 stage are implemented as fixed function circuitry.

The viewport SCC 1912 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1914 stage.

The rasterization 1914 stage converts the 3D geometric primitives into 2D fragments (e.g. capable of being utilized for display, etc.). The rasterization 1914 stage may be configured to utilize the vertices of the geometric primitives to setup a set of plane equations from which various attributes can be interpolated. The rasterization 1914 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1914 stage generates fragment data (e.g., interpolated vertex attributes associated with a particular sample location for each covered pixel) that are transmitted to the fragment shading 1916 stage.

The fragment shading 1916 stage processes fragment data by performing a set of operations (e.g., a fragment shader or a program) on each of the fragments. The fragment shading 1916 stage may generate pixel data (e.g., color values) for the fragment such as by performing lighting operations or sampling texture maps using interpolated texture coordinates for the fragment. The fragment shading 1916 stage generates pixel data that is transmitted to the raster operations 1918 stage.

The raster operations 1918 stage may perform various operations on the pixel data such as performing alpha tests, stencil tests, and blending the pixel data with other pixel data corresponding to other fragments associated with the pixel. When the raster operations 1918 stage has finished processing the pixel data (e.g., the output data 1902), the pixel data may be written to a render target such as a frame buffer, a color buffer, or the like.

It will be appreciated that one or more additional stages may be included in the graphics processing pipeline 1900 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1910 stage). Other types of graphics processing pipelines are contemplated as being within the scope of the present disclosure. Furthermore, any of the stages of the graphics processing pipeline 1900 may be implemented by one or more dedicated hardware units within a graphics processor such as parallel processing unit 1302a. Other stages of the graphics processing pipeline 1900 may be implemented by programmable hardware units such as the streaming multiprocessor 1600 of the parallel processing unit 1302a.

The graphics processing pipeline 1900 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 1302a. The API provides an abstraction for a programmer that lets a programmer utilize specialized graphics hardware, such as the parallel processing unit 1302a, to generate the graphical data without requiring the programmer to utilize the specific instruction set for the parallel processing unit 1302a. The application may include an API call that is routed to the device driver for the parallel processing unit 1302a. The device driver interprets the API call and performs various operations to respond to the API call. In some instances, the device driver may perform operations by executing instructions on the CPU. In other instances, the device driver may perform operations, at least in part, by launching operations on the parallel processing unit 1302a utilizing an input/output interface between the CPU and the parallel processing unit 1302a. In an embodiment, the device driver is configured to implement the graphics processing pipeline 1900 utilizing the hardware of the parallel processing unit 1302a.

Various programs may be executed within the parallel processing unit 1302a in order to implement the various stages of the graphics processing pipeline 1900. For example, the device driver may launch a kernel on the parallel processing unit 1302a to perform the vertex shading 1906 stage on one streaming multiprocessor 1600 (or multiple streaming multiprocessor 1600 modules). The device driver (or the initial kernel executed by the parallel processing unit 1302a) may also launch other kernels on the parallel processing unit 1302a to perform other stages of the graphics processing pipeline 1900, such as the geometry shading 1910 stage and the fragment shading 1916 stage. In addition, some of the stages of the graphics processing pipeline 1900 may be implemented on fixed unit hardware such as a rasterizer or a data assembler implemented within the parallel processing unit 1302a. It will be appreciated that results from one kernel may be processed by one or more intervening fixed function hardware units before being processed by a subsequent kernel on a streaming multiprocessor 1600.

### LISTING OF DRAWING ELEMENTS

302 graph neural network
304 policy network
306 state value network
308 placement
310 updated placement
402 input tensor
404 convolution layer
406 convolution layer
408 maxpool layer
410 fully connected layer
502 block
504 block
506 block
508 block
510 block
512 block
600 placement routine
602 block
604 block
606 block
608 block
702 power plane
704 ground plane
706 transistor
708 transistor
710 shared diffusion region
712 pin connection
714 cut
716 dummy PMOS placement
800 circuit layout router
802 layout with device placement
804 genetic router
806 candidate routed layouts
808 reinforced learning model
810 DRC corrected routed layouts
812 final routed layout
900 incremental routing process
902 block
904 block
906 block
1000 genetic routing algorithm
1100 reinforcement learning artificial neural network
1102 convolution layers
1104 state embedding
1106 state value network
1108 policy network
1110 collected outputs
1112 action mask
1114 masked output
1116 Softmax layer
1118 action policies
1120 pooling layer
1122 vector
1300 computing system
1302a parallel processing unit
1302b parallel processing unit
1302c parallel processing unit
1302d parallel processing unit
1304 I/O unit
1306 front-end unit
1308 scheduler unit
1310 work distribution unit
1312 hub
1314 crossbar
1316 NVLink
1318 interconnect
1320 memory
1400 general processing cluster
1402 pipeline manager
1404 pre-raster operations unit
1406 raster engine
1408 work distribution crossbar
1410 memory management unit
1412 data processing cluster
1414 primitive engine
1416 M-pipe controller
1500 memory partition unit
1502 raster operations unit
1504 level two cache
1506 memory interface
1600 streaming multiprocessor
1602 instruction cache
1604 scheduler unit
1606 register file
1608 core
1610 special function unit
1612 load/store unit
1614 interconnect network
1616 shared memory/L1 cache
1618 dispatch
1700 processing system
1702 central processing unit
1704 switch
1706 parallel processing module
1800 exemplary processing system
1802 communications bus
1804 main memory
1806 input devices
1808 display devices
1810 network interface
1900 graphics processing pipeline
1902 output data
1904 data assembly
1906 vertex shading
1908 primitive assembly
1910 geometry shading
1912 viewport SCC
1914 rasterization
1916 fragment shading
1918 raster operations
1920 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method for generating device placements on a circuit layout, the method comprising:
applying a machine learning model to generate a routability estimation for a poly on the circuit layout;
utilizing the routability estimation in a reinforcement learning model to generate an action probability distribution for placement of device pairs on the poly; and
based on the action probability distribution, selecting a placement action on the poly; and
executing the action to place a particular device pair of the device pairs on the poly.

2. The method of claim 1, further comprising:
embedding devices and pins of the circuit in a graph neural network.

3. The method of claim 2, further comprising:
generating next embeddings for the graph neural network and applying the next embeddings to a policy network to generate the action probability distribution.

4. The method of claim 1, where the particular device pair comprises a dummy device.

5. The method of claim 1, wherein the action comprises placing the particular device pair with a shared diffusion region.

6. The method of claim 1, wherein the action comprises inserting a cut on the poly.

7. The method of claim 1, wherein the action comprises placing a pin on the circuit layout.

8. The method of claim 1, further comprising:
executing a simulated annealing algorithm to perform device pair swapping in the circuit layout.

9. A system comprising:
one or more processors; and
logic that when applied to the one or more processors:
operates a first reinforcement learning model to generate device placements on a circuit layout;
operates a genetic routing algorithm on the circuit layout to generate a plurality of candidate routed circuit layouts; and
operates a second reinforcement learning model to correct design rule constraint errors in the candidate routed circuit layouts.

10. The system of claim 9, the first reinforcement learning model comprising a graph neural network.

11. The system of claim 9, further comprising a machine learning model to generate routing estimations input to the first reinforcement learning model.

12. The system of claim 11, the machine learning model comprising a convolutional neural network.

13. The system of claim 9, further comprising feedback of a number of the design rule constraint errors to evolve the genetic routing algorithm.

14. The system of claim 13, wherein the design rule constraint errors are applied to a fitness function of the genetic routing algorithm.

15. The system of claim 14, wherein a number of unrouted terminal pairs is also applied to the fitness function of the genetic routing algorithm.

16. The system of claim 9, wherein the second reinforcement learning model comprises a convolutional neural network generating embeddings for a plurality of policy neural networks and a state value neural network.

17. The system of claim 16, wherein the policy neural network comprises a plurality of fully connected layers and an operation mask.

18. The system of claim 16, further comprising:
a pooling layer; and
the state value neural network comprising a plurality of fully connected layers coupled to receive an output of the pooling layer.

19. The system of claim 9, the reinforcement learning model configured to:
receive stick depiction images the candidate routed circuit layouts; and
transform the stick depiction images into action probabilities for correcting the design rule constraint errors.

20. The system of claim 19, wherein the transformation into the action probabilities is invariant in relation to a width of the stick depiction images.

21. The system of claim 9, the genetic routing algorithm further comprising:
a fitness function comprising a reciprocal of a weighted sum of a number of unrouted terminal pairs in the candidate routed circuit layouts and a number of the design rule constraint errors in the candidate routed circuit layouts.

22. A method comprising:
executing a simulated annealing-based placement and routing algorithm on a set of training circuits;
selecting resulting placements that produce routable cell layouts;
converting the placements into reinforced learning trajectories;
processing the reinforced learning trajectories through a machine learning model;
providing a current observation to the machine learning model to produce a probability distribution of a placement action to take; and
sampling the probability distribution to select one or more devices and pins to place on a circuit layout.
